(19) United States
(12) Patent Application Publication
(10) Pub. No.: US 2012/0087008 A1
(43) Pub. Date: Apr. 12, 2012

(54) DIFFRACTIVE OPTICAL ELEMENT, OPTICAL SYSTEM, AND OPTICAL APPARATUS

(75) Inventor: Reona Ushigome, Utsunomiya-shi (JP)

(73) Assignee: CANON KABUSHIKI KAISHA, Tokyo (JP)

(21) Appl. No.: 13/248,093

(22) Filed: Sep. 29, 2011

(30) Foreign Application Priority Data
Oct. 6, 2010 (JP) 2010-226882

(51) Int. Cl. G02B 5/18

(52) U.S. Cl. 359/576

(57) ABSTRACT

A diffractive optical element includes first and second diffraction gratings. A grating wall surface of the second diffractive grating is located on a surface extending a grating wall surface of the first diffractive grating or on a low refractive index region side of the first diffractive grating with respect to the surface extending the grating wall surface of the first diffractive grating. +1.3×|m|<|m1|<+2.0×|m|, −1.0×|m|<−|m2|<−0.3×|m|, and 0.94×|m|<|m1+m2|<1.05×|m| are satisfied. Here, m is a designed order, m1=(nd2−nd1)d1/λd, m2=(nd3−nd2)d2/λd, nd1 is a refractive index of the first material to d-line, nd2 is a refractive index of the second material to the d-line, nd3 is a refractive index of the third material to the d-line, λd is a wavelength of the d-line, d1 and d2 are grating heights of the first and second diffraction gratings.

### BACKGROUND OF THE INVENTION

1. Field of the Invention

The present invention relates to a diffractive optical element used for a lens in an optical system, that optical system, and an optical apparatus.

2. Description of the Related Art

One conventional diffractive optical element used as a lens in an optical system includes two contacted diffraction gratings in which a material and a grating height of each diffraction grating are appropriately set, and provides high diffractive efficiency in a wide wavelength range. When a light flux enters the diffractive optical element having a Blazed structure, which is provided with the grating surface and the grating wall surface, the incident light flux is reflected and refracted on the grating wall surface and unnecessary light (flare) is generated.

Japanese Patent Laid-Open Nos. (“JPs”) 2003-240931 and 2004-126394 disclose a diffractive optical element including an absorption film on the grating wall surface so as to reduce the unnecessary light (flare) on the grating wall surface. JP 2009-217139 discloses a calculation of the diffractive efficiency using the Rigorous Coupled Wave Analysis (“RCWA”).

In a diffractive optical element used as a lens in an optical system, particularly problematic unnecessary light is one caused by a total reflection at an interface between a high refractive index medium and a low refractive index medium, of a light flux incident at an obliquely incident angle (off-screen light's incident angle) different from the designed incident light flux. However, JPs 2003-240931, 2004-126394, and 2009-217139 are silent about this unnecessary light, and thus their unnecessary light restraining effects are insufficient.

### SUMMARY OF THE INVENTION

The present invention provides a diffractive optical element, an optical system, and an optical apparatus, which can restrain unnecessary light.

A diffractive optical element according to one aspect of the present invention is used for a lens surface in an optical system and includes a first diffraction grating made by adhering a grating interface of a diffractive grating made of a first material to a grating interface of a diffractive grating made of a second material, and a second diffraction grating made by adhering a grating interface of the diffractive grating made of the second material to a grating interface of a diffractive grating made of a third material. A grating wall surface of the second diffractive grating is located on a surface extending a grating wall surface of the first diffractive grating or on a low refractive index region side of the first diffractive grating with respect to the surface extending the grating wall surface of the first diffractive grating. The following conditional expressions are satisfied:

+1.3×|m|<|m1|<+2.0×|m|,

−1.0×|m|<−|m2|<−0.3×|m|, and

0.94×|m|<m1+m2|<1.05×|m|,

where m is a designed order, m1=(nd2−nd1)d1/λd, m2=(nd3−nd2)d2/λd, nd1 is a refractive index of the first material to d-line, nd2 is a refractive index of the second material to the d-line, nd3 is a refractive index of the third material to the d-line, λd is a wavelength of the d-line, d1 is a grating height of the first diffraction grating, and d2 is a grating height of the second diffraction grating.

Further features and aspects of the present invention will become apparent from the following description of exemplary embodiments with reference to the attached drawings.

### BRIEF DESCRIPTION OF THE DRAWINGS

FIG. 1 illustrates plane and side views of a diffractive optical element according to a comparative example 1.

FIG. 2 is a partially sectional view taken along a line A-A′ in FIG. 1 according to the comparative example 1.

FIGS. 3A and 3B are graphs of diffraction efficiencies for a designed incident light flux in the diffractive optical element illustrated in FIG. 1 according to the comparative example 1.

FIG. 4 is a schematic diagram illustrating a propagation of the unnecessary light for the designed incident light flux in the diffractive optical element illustrated in FIG. 1 according to the comparative example 1.

FIGS. 5A and 5B are graphs of diffraction efficiencies of the diffractive optical element illustrated in FIG. 1 for light having an off-screen incident angle of +10° according to the comparative example 1.

FIG. 6 is a schematic diagram illustrating a propagation of the unnecessary light for the light having an off-screen incident angle of +10° in the diffractive optical element illustrated in FIG. 1 according to the comparative example 1.

FIGS. 7A and 7B are graphs of diffraction efficiencies of the diffractive optical element illustrated in FIG. 1 for light having an off-screen incident angle of −10° according to the comparative example 1.

FIG. 8 is a schematic diagram illustrating a propagation of the unnecessary light for the light having an off-screen incident angle of −10° in the diffractive optical element illustrated in FIG. 1 according to the comparative example 1.

FIG. 9 is an optical path diagram of an optical system that includes the diffractive optical element illustrated in FIG. 1 according to the comparative example 1.

FIG. 10 is a schematic diagram of unnecessary light of the diffractive optical element illustrated in FIG. 1 in the optical system illustrated in FIG. 9 according to the comparative example 1.

FIG. 11 is a partially enlarged sectional view of the diffractive optical element illustrated in FIG. 10.

FIG. 12 illustrates plane and side views of a diffractive optical element according to a first embodiment of the present invention.

FIG. 13 is a partially enlarged perspective view of a diffraction grating unit illustrated in FIG. 12 according to the first embodiment.

FIG. 14 is a partially enlarged sectional view of the diffractive optical element illustrated in FIG. 12 according to the first embodiment.

FIG. 15 is a partially enlarged view of FIG. 14 according to the first embodiment.

FIGS. 16A and 16B are graphs of diffraction efficiencies of the diffractive optical element illustrated in FIG. 12 for designed incident light flux according to the first embodiment.

FIG. 17 is a schematic diagram illustrating a propagation of the unnecessary light for the designed incident light flux in the diffractive optical element illustrated in FIG. 12 according to the first embodiment.

FIG. 18 is an optical path diagram of an optical system that includes the diffractive optical element illustrated in FIG. 12 according to the first embodiment.

FIG. 19 is a schematic diagram of unnecessary light in the diffractive optical element illustrated in FIG. 12 in the optical system illustrated in FIG. 18 according to the first embodiment.

FIGS. 20A and 20B are graphs of diffraction efficiencies of the diffractive optical element illustrated in FIG. 12 for light having an off-screen incident angle of +10° according to the first embodiment.

FIGS. 21A and 21B are schematic diagrams illustrating a propagation of the unnecessary light of the diffractive optical element illustrated in FIG. 12 for the light having an off-screen incident angle of +10° according to the first embodiment.

FIGS. 22A and 22B are graphs of diffraction efficiencies of the diffractive optical element illustrated in FIG. 12 for light having an off-screen incident angle of −10° according to the first embodiment.

FIGS. 23A and 23B are schematic diagrams illustrating a propagation of the unnecessary light for the light having an off-screen incident angle of −10° in the diffractive optical element illustrated in FIG. 12 according to the first embodiment.

FIG. 24 is a graph of diffractive efficiency of a diffractive optical element for a designed incident light flux according to a second embodiment of the present invention.

FIG. 25 is a graph of diffractive efficiency for light having an off-screen incident angle of +10 degrees in the diffractive optical element illustrated in FIG. 24 according to the second embodiment.

FIG. 26 is a graph of diffractive efficiency of the diffractive optical element illustrated in FIG. 24 for light having an off-screen incident angle of −10° according to the second embodiment.

FIGS. 27A and 27B are schematic diagrams of a device structure having a different refractive index relationship according to the second embodiment.

FIG. 28 is a schematic diagram of a device structure of a diffractive optical element according to a third embodiment of the present invention.

FIG. 29 is a graph of diffractive efficiency for a designed incident light flux of the diffractive optical element according to the third embodiment of the present invention.

FIG. 30 is a graph of diffractive efficiency of the diffractive optical element illustrated in FIG. 29 for light having an off-screen incident angle of +10° according to the third embodiment.

FIG. 31 is a schematic diagram illustrating a propagation of the unnecessary light in FIG. 30 according to the third embodiment.

FIG. 32 is a graph of diffractive efficiency of the diffractive optical element illustrated in FIG. 29 for light having an off-screen incident angle of −10° according to the third embodiment.

FIG. 33 is a partially enlarged sectional view of a diffractive optical element according to a comparative example 2.

FIG. 34 is a graph of diffractive efficiency of the diffractive optical element illustrated in FIG. 33 for light having an off-screen incident angle of +10° according to the comparative example 2.

FIG. 35 is a schematic diagram illustrating a propagation of the unnecessary light in FIG. 34 according to the comparative example 2.

### DESCRIPTION OF THE PREFERRED EMBODIMENTS

A description will now be given of a comparative example 1 to be compared with embodiments.

### Comparative Example 1

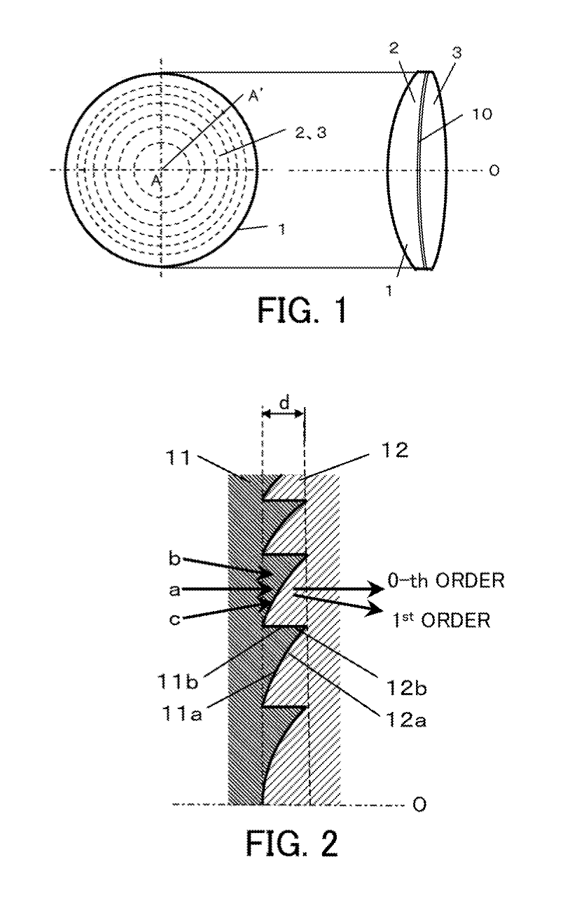

FIG. 1 illustrates a front view and a side view of a diffractive optical element (“DOE”) 1 as a comparative example. The DOE 1 includes a diffraction grating unit 10 between opposite surfaces of substrate lenses 2 and 3 in the optical axis direction each having a flat plane or a curved surface. The diffraction grating unit 10 has a concentric diffraction grating shape around an optical axis O, and possesses a lens function.

FIG. 2 is a partially enlarged sectional view taken along a line A-A′. For convenience, the surfaces of the substrate lenses 2, 3 which form the diffraction grating unit 10 are assumed to be flat. The diffraction grating unit 10 includes a diffraction grating made of a material 11 and a diffraction grating made of a material 12 which are contacted to each other. Thus, a DOE that includes two contacted diffraction gratings made of a low refractive index high dispersion material and a high refractive index low dispersion material, respectively, and having appropriately set heights, will be referred to as an “contacting two-layer DOE” hereinafter. The contacting two-layer DOE can generally realize high diffractive efficiency in a wide wavelength range for diffracted light of a specific order.

Each diffraction grating of the DOE 1 has a concentric Blazed structure including grating surfaces and grating wall surfaces. Each diffraction grating has a gradually changing grating pitch from the optical axis O to the outer circumference, and realizes a lens operation (such as a light converging effect and a diverging effect). The grating surfaces contact each other with no spaces and the grating wall surfaces contact each other with no spaces so as to serve as one diffraction grating unit as a whole. The Blazed structure enables incident light upon the DOE 1 to be mainly diffracted in a specific diffractive order (+1^{st} order in the figure) direction relative to the 0^{th} order diffracted direction that transmits the diffraction grating unit 10 without diffractions.

Since a working wavelength range (also referred to as a “designed wavelength range”) of the DOE 1 is a visible wavelength range, different materials 11 and 12 and grating heights are selected so as to provide high diffractive efficiency of the +1^{th} order diffracted light in the overall visible wavelength range.

In order to maximize the diffractive efficiency of diffracted light of a specific order in the use wavelengths λ in the contacting two-layer DOE illustrated in FIG. 2, an integrated value of a maximum optical path length difference of a grating unit over the diffraction grating is determined to be integer times as large as the design wavelength in accordance with the scalar diffraction theory. The condition that maximizes the diffractive efficiency of the diffracted light of the diffractive order m is given as follows for a ray that has the designed wavelength λ and perpendicularly enters a base surface (diffracted surface) of the diffraction grating:

(n12−n11)d1=mλ Expression 1

In Expression 1, n11 is a refractive index of the material 11 for the designed wavelength λ, n12 is a refractive index of the material 12 for the designed wavelength λ, d1 is a grating height of the diffraction grating, and m is a diffractive order. Herein, a positive diffractive order is set to a diffractive order of a ray that diffracts below the 0^{th} order diffracted light illustrated in FIG. 2, and a negative diffractive order is set to a diffractive order of a ray that diffracts above the 0^{th} order diffracted light.

The grating height of Expression 1 is positive when n11<n12 and the grating height of the material 11 increases (and the grating height of the material 12 decreases) from the bottom to the top in FIG. 2. The grating height of Expression 1 is negative when n11>n12 and the grating height of the material 11 decreases (and the grating height of the material 12 increases) from the bottom to the top in FIG. 2.

In the DOE illustrated in FIG. 2, the diffractive efficiency η(λ) for the working wavelength λ is given as follows:

$$\begin{matrix}η ( λ ) = {sinc}^{2} [ Π \{ m - ( n 12 - n 11 ) d 1 / λ \} ] \\ = {sinc}^{2} [ Π \{ m - ϕ 0 / λ \} ]\end{matrix} \qquad Expression 2$$

φ0 in Expression 2 can be expressed as follows:

φ0=(n12−n11)d1 Expression 3

High diffractive efficiency can be obtained in the overall working wavelength range by using a low refractive index high dispersion material for the material 11 and a high refractive index low dispersion material for the material 12 and by properly setting the grating heights.

When the DOE is calculated using the RCWA, the behavior of the grating wall surface is converted into the diffractive order and can be calculated as diffracted light of a high order. In the RCWA calculation, the calculation order is made equal to or higher than an order in which the unnecessary diffracted light can sufficiently attenuate. The number of levels (the number of divisional stages of the diffraction grating) is equal to or higher than the calculation order since the diffracted light corresponding to the number of levels occurs as a calculational error.

The diffraction grating 11 is made of fluorine acrylic ultraviolet curable resin mixed with ITO nanoparticles (nd=1.5045, νd=16.3, θgF=0.390, and n550=1.5111). The diffraction grating 12 is made of acrylic ultraviolet curable resin mixed with ZrO₂ nanoparticles (nd=1.5677, νd=47.0, θgF=0.569, and n550=1.5704). “θgF” is a partial dispersion ratio between the g-line and the F-line, and n550 is a refractive index to a wavelength of 550 nm. The grating height d is 9.29 μm, and the designed order is +1^{st} order. The designed order is not 0^{th}.

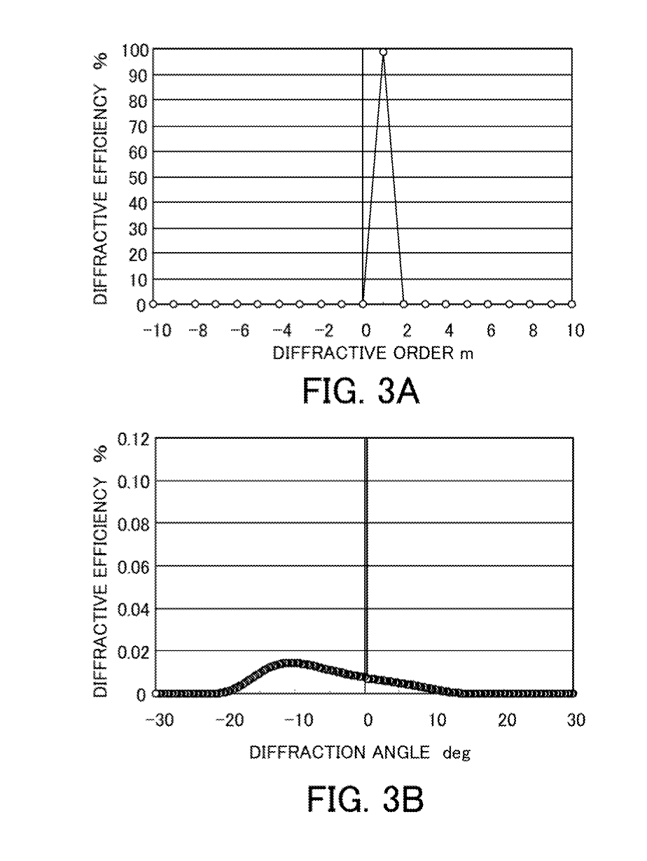

FIGS. 3A and 3B are graphs of RCWA calculation results using an incident angle of 0° (“a” in FIG. 2), a grating pitch of 100 μm, and a wavelength of 550 nm. FIG. 3A illustrates diffractive efficiency near the +1^{st} order diffracted light as the designed order, where the abscissa axis denotes a diffractive order and the ordinate axis denotes the diffractive efficiency (%). FIG. 3B illustrates a high diffraction angle range by enlarging a low diffractive efficiency part of the ordinate axis of FIG. 3A, and by converting the abscissa axis from the diffractive order into the diffraction angle. The abscissa axis denotes a diffraction angle (degree), and the ordinate axis denotes the diffractive efficiency (%). The diffraction angle is set positive in the downward direction in FIG. 2.

Although the diffractive efficiency concentrates on the +1^{st} order diffracted light as the designed order in FIG. 3A, the diffractive efficiency is 98.76% (with a diffractive order of +1^{st} order and a diffraction angle of)+0.20° and does not become 100%. The remaining light becomes unnecessary light having a peak in a specific angle direction, and propagates as illustrated in FIG. 3B.

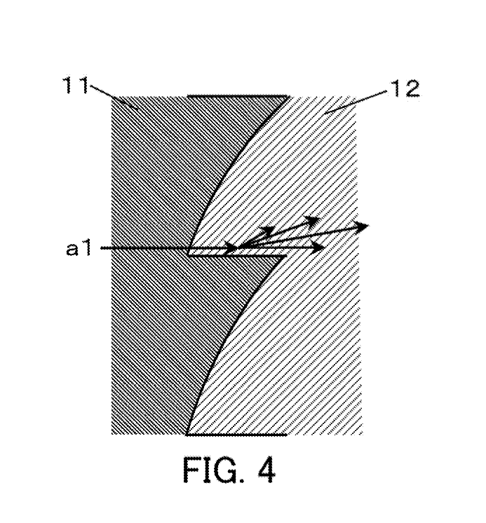

FIG. 4 is a schematic diagram of a propagation of the DOE of the unnecessary light for the designed incident light flux. As illustrated in FIG. 4, a component “a1” of an incident light flux upon the vicinity of the grating wall surface diffracts towards the high refractive index material side (material 12 side) on the grating wall surface, thereby the unnecessary light propagates. Since it is rare to directly capture a high brightness light source, such as the sun in daylight, at the designed incident angle (an incident angle of image pickup light), the influence of this unnecessary light is little problematic.

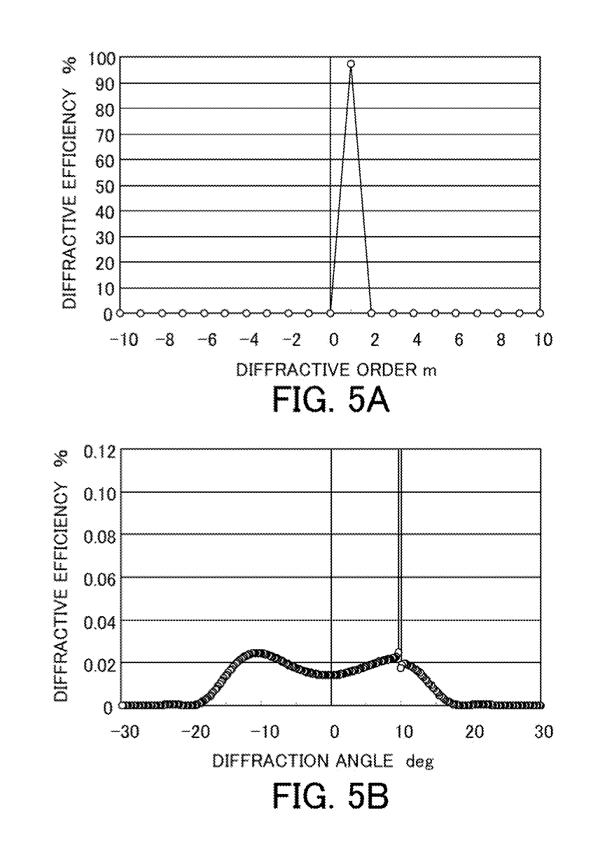

FIGS. 5A and 5B are graphs of RCWA calculation results using an incident angle of +10°, a grating pitch of 100 μm, and a wavelength of 550 nm by supposing incident light “b” illustrated in FIG. 2 which is incident at an obliquely incident angle (off-screen light's incident angle) below the designed incident angle of this DOE. The incident angle is set positive in the downward direction in FIG. 2.

FIG. 5A illustrates diffractive efficiency near the +1^{st} order diffracted light as the designed order, where the abscissa axis denotes a diffractive order and the ordinate axis denotes diffractive efficiency (%). FIG. 5B illustrates a high diffraction angle range by enlarging a low diffractive efficiency part of the ordinate axis of FIG. 5A and by converting the diffractive order of the abscissa axis into a diffraction angle. The diffraction angle is set positive in the downward direction in FIG. 2.

As illustrated in FIG. 5A, the +1^{st} order diffracted light as the designed order provides the highest diffractive efficiency, but its diffractive efficiency is 97.15% (with a diffractive order of +1^{st} order and a diffraction angle of)+9.94° smaller than that of the designed incident angle of 0°. This +1^{st} order diffracted light does not reach the image plane, and thus its influence is small.

The remaining unnecessary light becomes unnecessary light having a peak in the specific angle direction or in the about −10° direction, and propagates as illustrated in FIG. 5B. The propagation direction is approximately equal to an exit direction of −9.94° direction in which a component of off-screen light flux having an incident angle of +9.94° incident upon the grating wall surface is totally reflected and propagated.

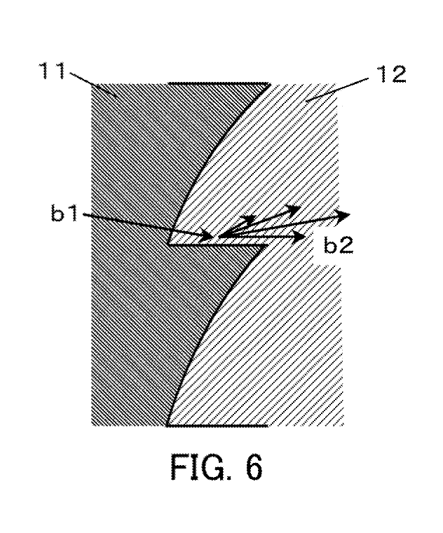

The light flux enters the grating wall surface at an incident angle of +80.06° larger than a critical angle of 74.2° from the high refractive index material side to the low refractive index material side. FIG. 6 is a schematic diagram of a propagation of the unnecessary light of the DOE for the off-screen light flux having an incident angle of +10°. The unnecessary light spreads from the peak in the about −10° direction to a high angle range. This is because as illustrated in FIG. 6, a component “b1” in the incident light flux which diffracts on the grating surface and enters a region near the grating wall surface is totally reflected on the grating surface wall and propagates in the −10° direction. It is thus conceivable that the unnecessary light spreads and propagates around the total reflection exiting direction.

The unnecessary light spreads to a region near the diffraction angle of 0° (“b2” of FIG. 6). Since the diffraction angle of 0° (“b1” of FIG. 6) is approximately equal to the diffraction angle of 0.20° of the +1^{st} order diffracted light (which is the +1^{st} order diffracted light in FIG. 2) derived from the designed incident angle of 0° (“a” of FIG. 2), unnecessary light that exits at an angle near the diffraction angle of +0.20° reaches the image plane among the unnecessary light derived from off-screen light having an incident angle of +10°.

Although the diffractive order and the diffraction angle with which the unnecessary light from the off-screen incident light reaches the image plane are different according to an optical system subsequent to the DOE, at least diffracted light of unnecessary light from off-screen light reaches the image plane in any optical systems, when the diffracted light has a diffraction angle approximately equal to a diffraction angle at which a designed diffractive order having a designed incident angle propagates, thereby causing a deterioration of the imaging performance.

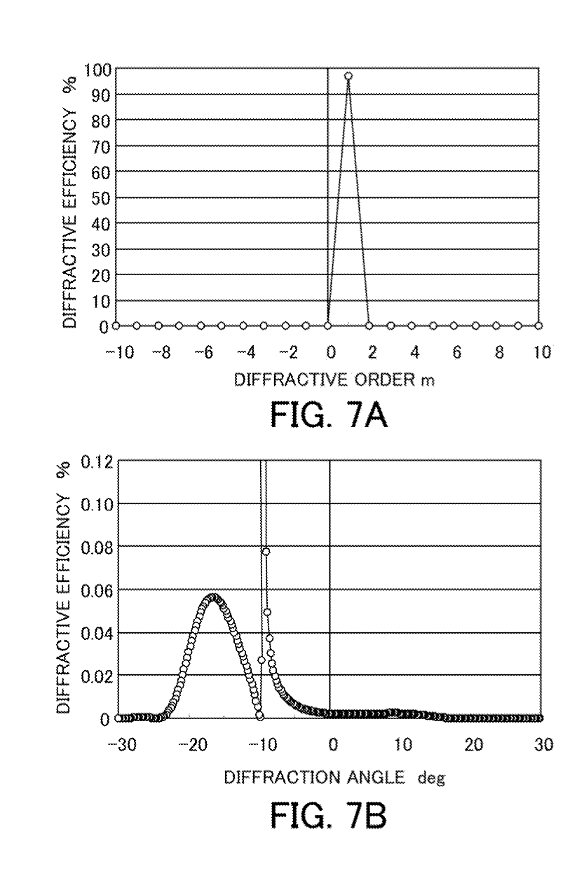

FIGS. 7A and 7B are graphs of RCWA calculation results using an incident angle of −10°, a grating pitch of 100 μm, and a wavelength of 550 nm by supposing incident light “c” illustrated in FIG. 2 which is incident with an obliquely incident angle (off-screen light's incident angle) below the designed incident angle of this DOE. The incident angle is set positive in the downward direction in FIG. 2.

FIG. 7A illustrates diffractive efficiency near the +1^{st} order diffracted light as the designed order, where the abscissa axis denotes a diffractive order and the ordinate axis denotes diffractive efficiency (%). FIG. 7B illustrates a high diffraction angle range by enlarging a low diffractive efficiency part of the ordinate axis of FIG. 7A and by converting the diffractive order of the abscissa axis into a diffraction angle. The abscissa axis denotes a diffraction angle (degree), and the ordinate axis denotes diffractive efficiency (%). The diffraction angle is set positive in the downward direction in FIG. 2.

In FIG. 7A, the +1^{st} order diffracted light as the designed order provides the highest diffractive efficiency, but its diffractive efficiency is 97.00% (with a diffractive order of +1^{st} order and a diffraction angle of −9.42° smaller than that of the designed incident angle 0°.

As illustrated in FIG. 7B, the remaining unnecessary light becomes unnecessary light having a peak in a specific angle direction and propagates. This unnecessary light has peaks in the about −17° direction and in the about +10° direction. The propagation directions are approximately equal to an exit direction of −18.6° direction of transmitting light and an exit direction of +9.5° direction of reflected light on the wall surface derived from the off-screen light flux component having an incident angle of −10° incident upon the grating wall surface. The light flux enters the grating wall surface at +80° from the low refractive index material side to the high refractive index material side. Thus, the transmittance of the transmitting light is 91% and the reflectance of the reflected light is 9%. It has a larger peak in the about −17° direction and a smaller peak in the about +10° direction.

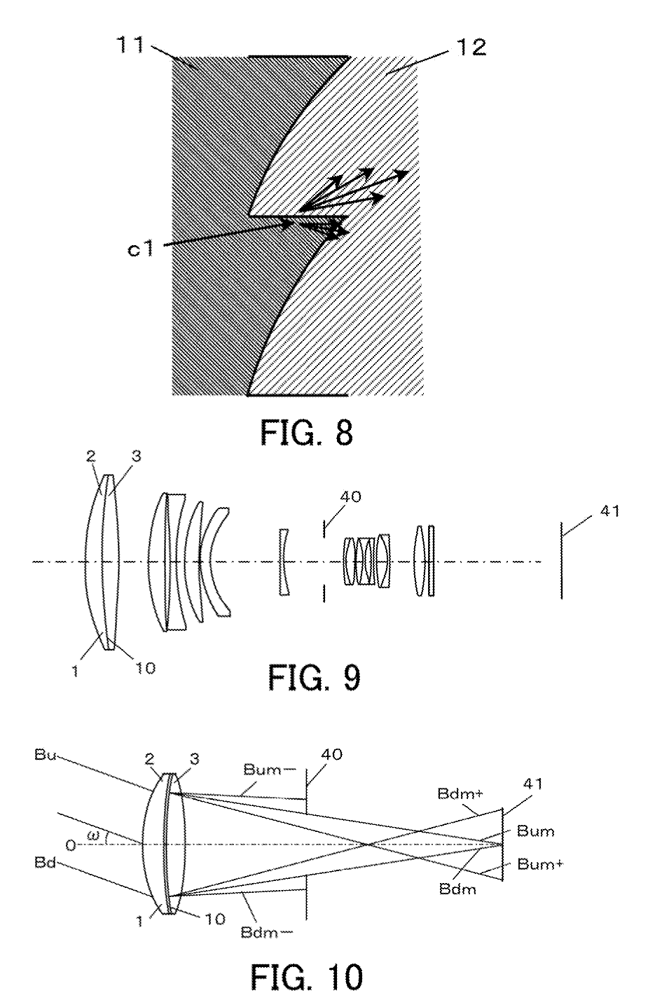

FIG. 8 is a schematic diagram of the DOE of a propagation of the unnecessary light for the off-screen light flux having an incident angle −10°. The unnecessary light spreads from the peak to a high angle range. This is because as illustrated in FIG. 8, a component “c1” of the incident light flux that enters an region near the grating wall surface is split into the transmitting light and the reflected light on the grating surface wall, propagated, and spread around each peak. The unnecessary light does not spread to the region near the diffraction angle of 0°, and a numerical value of the diffractive efficiency is small. Therefore, it is less likely that the unnecessary light from the off-screen light having the incidence angle −10° reaches the image plane and deteriorates the imaging performance.

The conventional approach treats a light flux incident upon a grating wall surface as a geometric optics phenomenon, and in that case the light incident upon the grating wall surface exits and propagates in a specific direction in accordance with the Snell's law. However, it is found that when the RCWA calculation is simultaneously performed for the grating surface and the grating wall surface, the light that enters the grating wall surface and exits from it has an exit direction approximately equal to the exit direction under the Snell's law, but does not perfectly accord with the Snell's law, and the exit light has a certain spread.

Herein, the diffractive efficiency of the grating pitch of 100 μm as one basis is addressed. In the annulus having a wide grating pitch, the wall surface has a smaller contribution, the diffractive efficiency of the designed order becomes higher, and the diffractive efficiency of the unnecessary light becomes lower. Although the propagation direction of this unnecessary light is not illustrated, it does not depend upon the grating pitch and the propagation direction was the same.

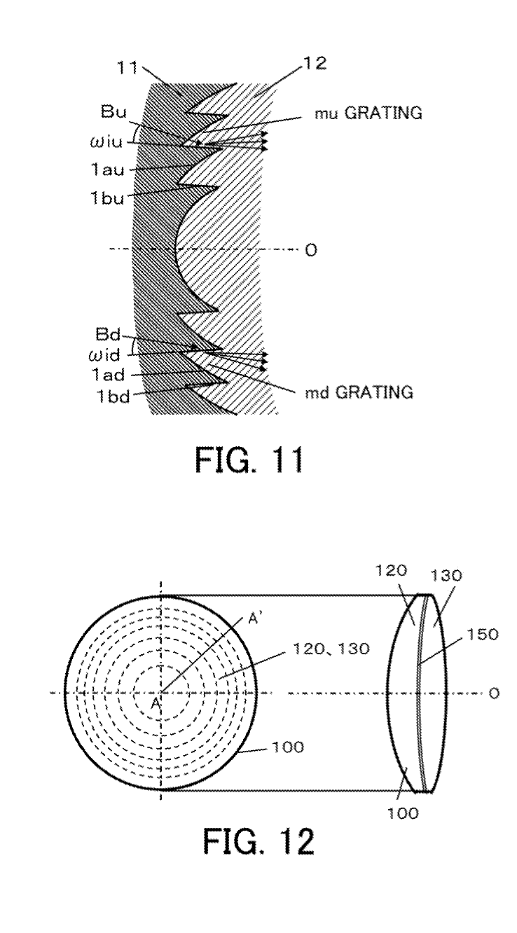

Next follows a description of unnecessary light when off-screen light enters the DOE 1 that is applied to the actual optical system. FIG. 9 is an optical path diagram of a telephoto type image pickup optical system using the DOE 1, where f=392.00 mm, fno=4.12, a half field angle is 3.16°, and a diffracting surface is provided on the second surface. FIG. 10 is a schematic diagram illustrating unnecessary light of the DOE 1 in the optical system illustrated in FIG. 9. FIG. 11 is a partially enlarged sectional view of the DOE 1.

For better understanding of the grating shape, FIG. 11 is exaggeratedly deformed in the grating depth direction, and the number of gratings is depicted less than the actual number. In FIGS. 10 and 11, off-screen light fluxes Bu and Bd incident at an incident angle of ω to the optical axis O pass the substrate lens 2 of the DOE 1, and enter the mu grating and the md grating which are the m-th diffraction gratings from the optical axis O in the upper direction and the lower direction. The incident angle of the off-screen light flux Bu upon the mu grating is ωiu to the angularly center direction of the image pickup light flux. The incident angle of the off-screen light flux Bd upon the md grating is ωid to the angularly center direction of the image pickup light flux. The grating wall surface direction is assumed to be equal to the angularly center direction of the image pickup light flux incident upon each grating.

Herein, it is assumed that an incident angle of each of the off-screen light fluxes Bu, Bd is off-screen +10° and the incident angle ω is +13.16° to the optical axis direction. The influence of the unnecessary light of the DOE is comparatively inconspicuous at an angle smaller than this incident angle because there are increasing ghosts generated on the lens surface and caused by reflections on the imaging plane and scatters in the lens and caused by micro roughness on the surface. In addition, the influence of the unnecessary light of the DOE is comparatively small at an angle larger than this incident angle due to reflections on a front lens surface and light shields by the lens barrel.

The mu grating has a grating shape in which the grating height of the material 11 increases from the bottom to the top in the figure (the grating height of the material 12 decreases) and the off-screen incident light flux Bu is a light flux incident in the downward direction. An incident angle ωiu to the grating is about +10°.

The relationship between this mu grating and the off-screen incident light flux Bu corresponds to the relationship among FIGS. 5A, 5B, and 6, and the unnecessary light spreads on the grating wall surface lbu around the total reflection exiting direction and propagates. As illustrated in FIG. 6, the unnecessary light spreads to a region near a diffraction angle of +0.21° approximately equal to a diffraction angle of the +1^{st} order diffracted light from the designed incident angle of 0°. Hence, the unnecessary light (“Bum” in FIG. 10) exiting to the region near the diffraction angle of +0.21° reaches the imaging plane 41 among the unnecessary light from the off-screen light having an incident angle of 10°.

From FIGS. 5A and 5B, the diffractive efficiency near the diffraction angle of 0° is 0.014% for the diffractive order of a −46^{th} order (diffraction angle of)+0.34°, and 0.014% for the diffractive order of a −47^{th} order (diffraction angle of)+0.14°. Although this diffractive efficiency has a low numerical value, its influence cannot be ignored if a high brightness light source, such as the sun in daylight, is located outside of the screen at the image pickup time.

Among unnecessary light from the off-screen light having an incident angle of +10°, unnecessary light (Bum− in FIG. 10 or a Peak of the Unnecessary Light) exiting at an angle smaller than the diffraction angle of 0° is shielded by the stop 40, and does not reach the imaging plane 41. Conversely, among the unnecessary light from the off-screen light having the incident angle of +10°, unnecessary light (Bum+ in FIG. 10) exiting at an angle larger than the diffraction angle of 0° and reaching the maximum image height position of the imaging plane 41 reaches the imaging plane 41.

The diffractive order and the diffraction angle (the relationship of Bum− to Bum to Bum+ in FIG. 10) with which the unnecessary light from the off-screen incident light reaches the image plane are different according to an optical system subsequent to the DOE and the stop position. However, at least diffracted light (Bum in FIG. 10) of unnecessary light from off-screen light reaches the image plane in any optical systems, when the diffracted light has a diffraction angle approximately equal to a diffraction angle at which a designed diffractive order having a designed incident angle propagates, thereby causing a deterioration of the imaging performance.

The md grating has a grating shape in which the grating height of the material 11 decreases (the grating height of the material 12 increases) from the bottom to the top in the figure and the off-screen incident light flux Bd is a light flux incident in the downward direction. An incident angle ωid to the grating is about +10°.

The relationship between this md grating and the off-screen incident light flux Bd corresponds to an (upside down) relationship among FIGS. 7A, 7B, and 8, and the unnecessary light spreads on the grating wall surface 1bd around the transmitting light exiting direction and the reflected light exiting direction and propagates. The unnecessary light amount in the transmitting light exiting direction is larger.

As illustrated in FIGS. 7A and 7B, the unnecessary light does not spread to the region near the diffraction angle of +0° approximately equal to the diffraction angle of the +1^{st} order diffracted light from the designed incident angle of 0°. Therefore, the unnecessary light (“Bdm” in FIG. 10) exiting to the region near the diffraction angle of 0° reaches the imaging plane 41 among the unnecessary light from the off-screen light having the incident angle of 10° but a numerical value of the diffractive efficiency is very small. More specifically, from FIGS. 7A and 7B, the diffractive efficiency is 0.0021% for the diffractive order of a +49^{th} order (diffraction angle of)+0.26°, and 0.0022% for the diffractive order of a +48^{th} order (diffraction angle of)+0.06°. The numerical value of this diffractive efficiency is too small to be influential even when there is a high brightness light source, such as the sun in the daylight.

Among the unnecessary light from the off-screen light having the incident angle of +10°, the unnecessary light (Bdm− in FIG. 10, +1^{st} order diffracted light and the peak of the unnecessary light) exiting at an angle smaller than the diffraction angle of 0° is shielded by the stop 40 and does not reach the imaging plane 41. Conversely, among the unnecessary light from the off-screen light having the incident angle of +10°, the unnecessary light (Bdm+ in FIG. 10) exiting at an angle larger than the diffraction angle of 0° and reaching the maximum image height position of the imaging plane 41 reaches the imaging plane 41.

The diffractive order and the diffraction angle (the relationship of Bdm− to Bdm to Bdm+ in FIG. 10) with which the unnecessary light from the off-screen incident light reaches the image plane are different according to an optical system subsequent to the DOE and the stop position. However, at least diffracted light (Bdm in FIG. 10) of unnecessary light from off-screen light reaches the image plane in any optical systems, when the diffracted light has a diffraction angle approximately equal to a diffraction angle at which a designed diffractive order having a designed incident angle propagates. In the and grating, the spread of the unnecessary light (“Bdm” in FIG. 10) exiting to the region near the diffraction angle of 0° is small, and a value of the diffractive efficiency is too small to be influential.

Thus, when the off-screen light flux having the incident angle of about 10° enters the optical system having the DOE 100, a large amount of the unnecessary light exits to the region near the diffraction angle of 0° caused by the mu grating and a small amount of the unnecessary light exits to the region near the diffraction angle of 0° caused by the md grating. Thus, the mu grating has a larger contribution to a drop of the imaging performance. Indeed, when the DOE 100 and the optical system are produced and used to take a picture, it is confirmed that the unnecessary light reaches the image plane and the imaging performance deteriorates.

The conventional approach treats a light flux incident upon a grating wall surface as a geometric optics phenomenon, and in that case the light incident upon the grating wall surface exits and propagates in a specific direction in accordance with the Snell's law. According to the conventional approach, only the total reflection occurs on the mu grating and 91% transmitting light and 9% reflected light occur on the md grating in the optical system illustrated in FIG. 9, but in that case these light fluxes are shielded by the stop 40 and do not reach the imaging plane 41. As discussed above, the conventional approach is insufficient to restrain the unnecessary light because a cause of the generation of the unnecessary light is not fully recognized.

A description will now be given of the embodiments of the present invention.

### First Embodiment

FIG. 12 illustrates a front view and a side view of a DOE 100 according to a first embodiment. The DOE 100 includes a diffraction grating unit 150 between opposite surfaces of substrate lenses 120 and 130 in the optical axis direction each having a flat plane or a curved surface. In this embodiment, the substrate lenses 120 and 130 have curved surfaces. The diffraction grating unit 150 has a concentric diffraction grating shape around an optical axis O, and possesses a lens function.

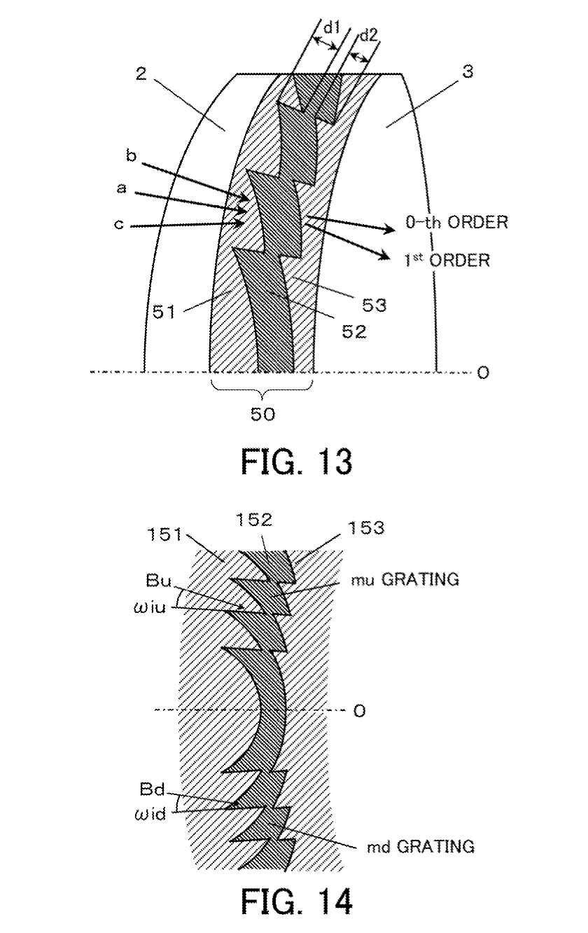

FIG. 13 is a partially enlarged perspective view of the diffraction grating unit 150 illustrated in FIG. 12. For better understanding of the grating shape, FIG. 13 is exaggeratedly deformed in the grating depth direction, and the number of gratings in these figures is depicted less than the actual number. The diffraction grating unit 150 includes a plurality of layered and contacted diffraction gratings, and is a DOE in which the material and the height of each diffraction grating are appropriately set. This DOE will be referred to as a “multi-layer DOE” hereinafter.

More specifically, the diffraction grating unit 150 is a multi-layer DOE in which the first diffraction grating and the second diffraction grating are closely arranged or layered. The first diffraction grating is a DOE made by adhering a grating interface of a diffraction grating made of a first material 151 to a grating interface of a diffraction grating made of a second material 152. The second diffraction grating is a DOE made by adhering a grating interface of a diffraction grating made of a second material 152 to a grating interface of a diffraction grating made of a third material 153.

Each diffraction grating has a concentric Blazed structure including grating surfaces and grating wall surfaces. Each diffraction grating has a gradually changing grating pitch from the optical axis O to the outer circumference, and realizes a lens operation (such as a light converging effect and a diverging effect).

In the first and second diffraction gratings, the grating surfaces contact each other with no spaces and the grating wall surfaces contact each other with no spaces so as to serve as one diffraction grating unit as a whole. The Blazed structure enables incident light upon the DOE 100 to be mainly diffracted in a specific diffractive order (+1^{st} order in the figure) direction relative to the 0^{th} order diffracted direction that transmits the diffraction grating unit 150.

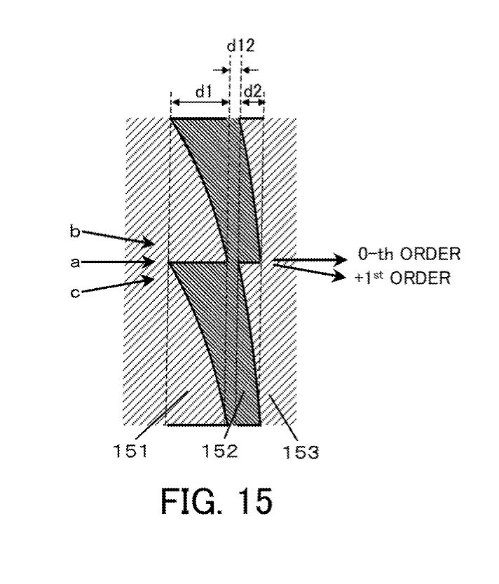

FIG. 14 is a partially enlarged sectional view if the DOE 100. For convenience, FIG. 14 is exaggeratedly deformed in the grating depth direction, and the number of gratings in these figures is depicted less than the actual number. FIG. 15 is an enlarged view of FIG. 14, and the surfaces of the substrate lenses 120, 130 which form the diffraction grating unit 150 are made flat.

Since a working wavelength range of the DOE 100 is a visible wavelength range, different materials 151, 152, and 153 and grating heights d1 and d2 are selected so as to provide high diffractive efficiency of the +1^{th} order diffracted light in the overall visible wavelength range.

In order to maximize the diffractive efficiency of diffracted light of a specific order among working wavelengths λ in the multi-layer DOE illustrated in FIG. 15, the material and grating height of each diffraction grating is determined in accordance with the scalar diffraction theory so that an integral value of a maximum optical path length difference of a grating unit over the diffraction grating can be integer times as large as the designed wavelength. The condition that maximizes the diffractive efficiency of the diffracted light of the diffractive order m is given as follows for a ray (“a” in FIG. 15) that has a designed wavelength λ and perpendicularly enters a base surface of the diffraction grating:

(n152−n151)d1+(n153−n152)d2=mλ Expression 4

In Expression 4, n151 is a refractive index of the material 151 for the designed wavelength λ, n152 is a refractive index of the material 152 for the designed wavelength λ, n153 is a refractive index of the material 153 for the designed wavelength λ, d1 is a grating height of the first diffraction grating, d2 is a grating height of the second diffraction grating, and m is a diffractive order.

Herein, a positive diffractive order is set to a diffractive order of a ray that diffracts below the 0th order diffracted light illustrated in FIG. 15, and a negative diffractive order is set to a diffractive order of a ray that diffracts above the 0^{th} order diffracted light. The refractive indexes n151, n152, and n153 satisfy n151>n152 and n152<n153. When the grating height of the material 151 decreases (when the grating height of the material 152 increases) from the bottom to the top in FIG. 15, both d1 and d2 become negative.

In the structure illustrated in FIG. 15, the diffractive efficiency η(λ) for the working wavelength λ is given as follows:

η(λ)sin c²[π{m−(φ1+φ2)/λ}]=sin c²[π{m−(m1+m2)}] Expression 5

m1, m2, φ1, and φ2 are expressed as follows:

m1=φ1/λ=(n152−n151)d1/λ Expression 6

m2=φ2/λ=(n153−n152)d2/λ Expression 7

In order to increase the diffractive efficiency of the diffracted light of the designed order over the visible area, the materials 151, 152, 153, and the grating heights d1, d2 are selected. In other words, the material and grating height of each diffraction grating are determined so that a maximum optical path length difference of the light passing a plurality of diffraction gratings (which is a maximum value of an optical path difference between a flight and a root of the diffracted portion) can be approximately integer times as large as the wavelength in the working wavelength range.

High diffractive efficiency can be obtained throughout the working wavelength region by properly setting the material and shape of the diffraction grating. In general, the grating height is defined as a height between the grating tip and the grating groove in the direction perpendicular to the grating period direction (surface normal direction). When the grating wall surface shifts from the surface normal direction or the grating tip deforms, it is defined as a distance from an intersection between the extension of the grating surface and the surface normal.

The material 151 is acrylic ultraviolet curable resin mixed with ZrO2 nanoparticles (nd=1.5677, νd=47.0, θgF=0.569, and n550=1.5704). The material 152 is fluorine acrylic ultraviolet curable resin mixed with ITO nanoparticles (nd=1.5045, νd=16.3, θgF=0.390, and n550=1.5111). The material 153 is acrylic ultraviolet curable resin mixed with ZrO2 nanoparticles (nd=1.5677, νd=47.0, θgF=0.569, and n550=1.5704).

The grating height d1 is −13.00 μm, and the grating height d2 is −3.71 μm, m1 is +1.40 and m2 is −0.40 in Expressions 6 and 7, and the designed order is +1st order. A grating wall surface of the second diffraction grating is located on an extension of the grating wall surface of the first diffraction grating, and a phase shift caused by a positional shift of the grating wall surface becomes minimum. An interval d12 between the first diffraction grating and the second diffraction grating is 1.00 μm.

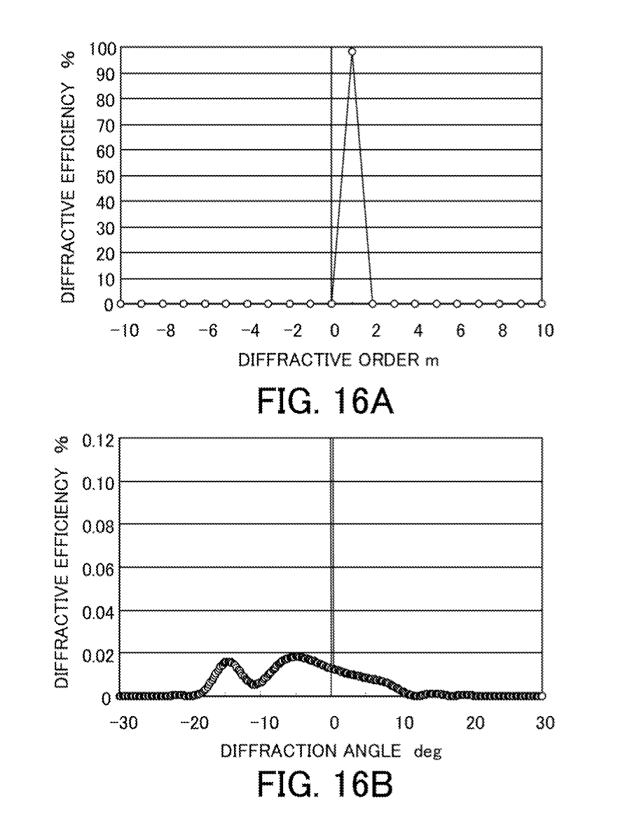

FIGS. 16A and 16B are graphs of RCWA calculation results using an incident angle of 0° (“a” illustrated in FIG. 15) as a designed incident angle of this DOE, a grating pitch of 100 μm, and a wavelength of 550 nm. FIG. 16A illustrates diffractive efficiency near the +1st order diffracted light as the designed order, where the abscissa axis denotes a diffractive order and the ordinate axis denotes diffractive efficiency (%). FIG. 16B illustrates a high diffraction angle range by enlarging a low diffractive efficiency part of the ordinate axis of FIG. 16A, and by converting the diffractive order of the abscissa axis into a diffraction angle. The abscissa axis denotes a diffraction angle (degree), and the ordinate axis denotes the diffractive efficiency (%). The diffraction angle is set positive in the downward direction in FIG. 15.

From FIG. 16A, the diffractive efficiency of the +1st order diffracted light as the designed order is 98.43% (with the diffraction angle of)+0.20°, which is equivalent with the diffractive efficiency of the +1st order diffracted light as the designed order of 98.76% (with the diffraction angle of)+0.20° in the adhesion double-layer diffraction grating. The remaining light becomes unnecessary light, and propagates as illustrated in FIG. 16B.

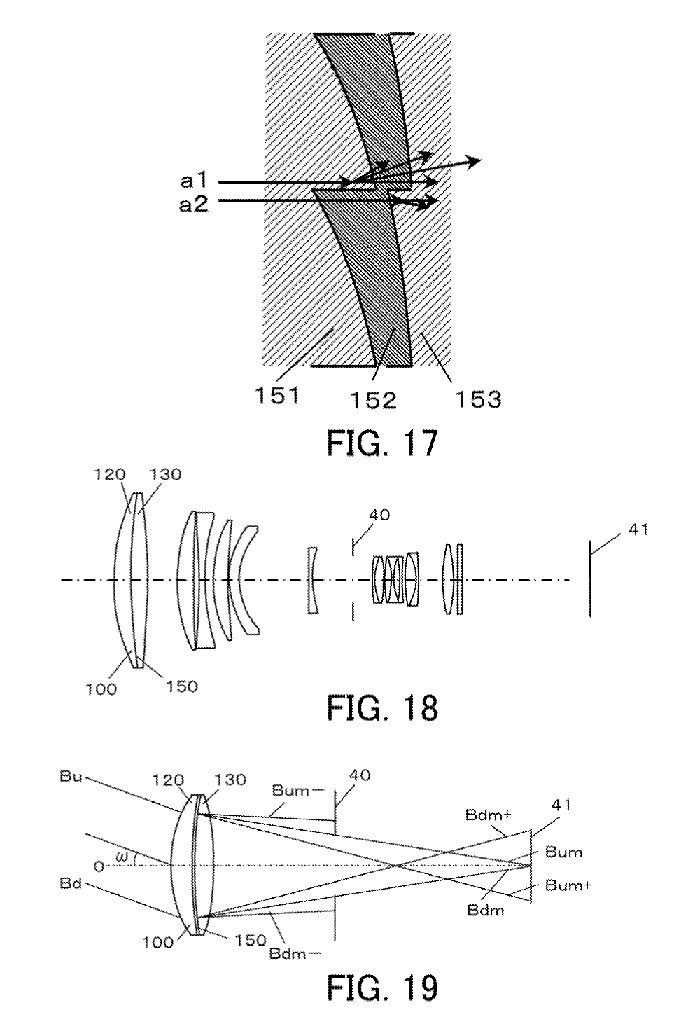

It is conceivable from FIG. 17 that a component “a1” of an incident light flux incident near the grating wall surface diffracts towards the high refractive index material side on the grating wall surface of the first diffraction grating, and a component a2 incident upon the low refractive index material side diffracts towards the high refractive index material side on the grating wall surface of the second diffraction grating. the −10° direction is a region in which the unnecessary light does not propagate. Thus, the behavior of the unnecessary light differs between the contacting two-layer DOE and the multi-layer DOE.

The supposed grating pitch is 100 μm as one reference. The grating pitch becomes larger for an annulus closer to the optical axis as illustrated in FIG. 12 and the influence by the grating wall surface reduces. Thus, the diffractive efficiency of the designed order becomes higher and the diffractive efficiency of the unnecessary light becomes lower.

When the overall DOE region is considered in this embodiment, a reduced amount of the diffractive efficiency of 0.33% of the +1st order diffracted light with a grating pitch of 100 μm is seldom influential or problematic because it is rare to directly capture a high brightness light source, such as the sun in daylight, at the designed incident angle (the incident angle of the image pickup light). The influence of the unnecessary light is also small.

Next follows a description of unnecessary light when off-screen light enters the DOE 100 that is applied to the actual optical system. FIG. 18 is an optical path diagram of a telephoto type image pickup optical system using the DOE 100, where f=392.00 mm, fno=4.12, a half field angle is 3.16°, and a diffracting surface is provided on the second surface. FIG. 19 is a schematic diagram illustrating unnecessary light of the DOE 100 in the optical system illustrated in FIG. 18.

The optical system to which the DOE 100 is applicable is not limited to the image pickup optical system illustrated in FIG. 18, and may be an image pickup lens of a video camera, an imaging optical system used in a wide wavelength range for an imaging scanner and a reader lens in a copier, an observation optical system for a telescope, or an optical viewfinder. An apparatus to which the optical system including the DOE 100 is applicable is not limited to the image pickup apparatus, and may be widely applicable to an optical apparatus.

In FIGS. 19 and 14, off-screen light fluxes Bu and Bd incident at an incident angle of ω to the optical axis O pass the substrate lens 120, and enter the mu grating and the md grating which are the m-th diffraction gratings from the optical axis O in the upper direction and in the lower direction. The incident angle upon the mu grating of the off-screen light flux Bu is ωiu to the principal ray direction. The incident angle upon the md grating of the off-screen light flux Bd is ωid to the principal ray direction. The grating wall surface direction is assumed to be equal to the principal ray direction.

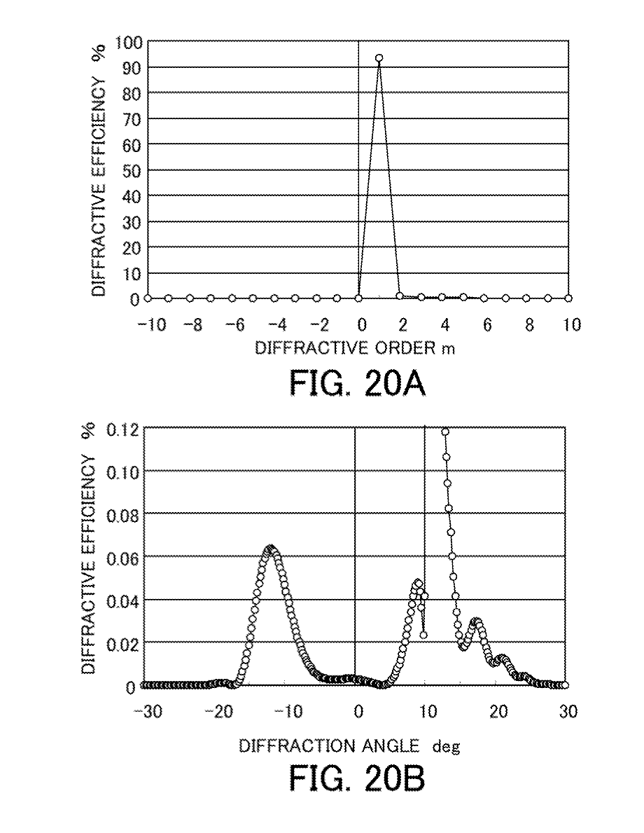

FIGS. 20A and 20B are graphs of RCWA calculation results using an incident angle of +10°, a grating pitch of 100 μm, and a wavelength of 550 nm by supposing a light flux (such as an incident light “b” illustrated in FIG. 15 and “Bu” in FIG. 14) which is incident at an obliquely incident angle (off-screen light incident angle) below the designed incident angle of this DOE. The incident angle is set positive in the downward direction in FIG. 14.

FIG. 20A illustrates diffractive efficiency near the +1st order diffracted light as the designed order, where the abscissa axis denotes a diffractive order and the ordinate axis denotes diffractive efficiency (%). FIG. 20B illustrates a high diffraction angle range by enlarging a low diffractive efficiency part of the ordinate axis of FIG. 20A and by converting the diffractive order of the abscissa axis into a diffraction angle. The abscissa axis denotes a diffraction angle (degree) and the ordinate axis denotes diffractive efficiency (%). The diffraction angle is set positive in the downward direction in FIG. 15.

In FIG. 20A, the +1st order diffracted light as the designed order provides the highest diffractive efficiency, but its diffractive efficiency is 93.16% (with a diffractive order of +1st order and a diffraction angle of)+10.20° smaller than that of the designed incident angle of 0° because it is inclined to the designed incident angle of 0°. Since this +1st order diffracted light does not reach the image plane, its influence is small.

The remaining unnecessary light becomes unnecessary light having a peak in a specific angle direction or in the about −10° direction and propagates as illustrated in FIG. 20B. The propagation direction is approximately equal to an exit direction of the −10° direction of the reflected light derived from an off-screen light flux having an incident angle of +10° that has been reflected on the first grating wall surface.

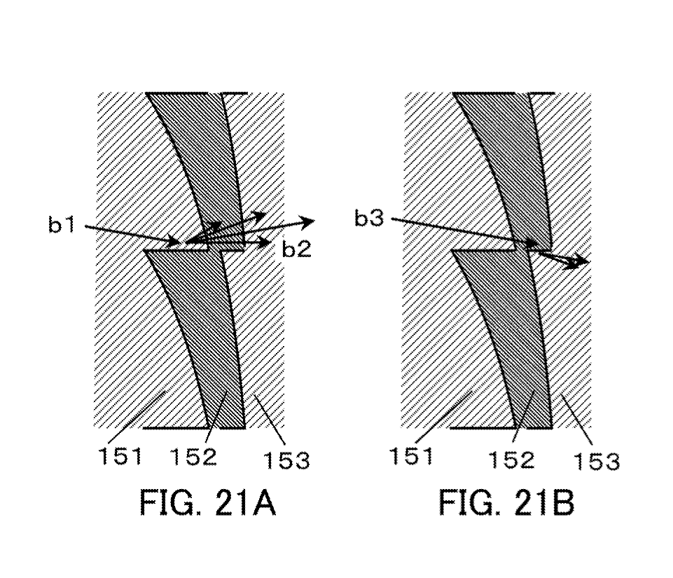

The peak angle of this unnecessary light is approximately equal to that of FIG. 5B, but the angular spread is different between FIG. 20B and FIG. 5B and the diffractive efficiency of FIG. 20B is lower at the low diffraction angle (low order). FIGS. 21A and 21B are schematic diagrams of a propagation of the unnecessary light relative to the off-screen light flux having the incident angle of +10° of the DOE 100.

When the multi-layer DOE of this embodiment is used, an amount of unnecessary light (“b2” in FIG. 21A) at a low diffraction angle (low order) can be reduced. In addition, as illustrated in FIG. 21B, a component “b3” of a light flux incident upon the second grating wall surface enters the grating wall surface of the second diffraction grating from the low refractive index material side to the high refractive index material side. Thus, the transmitting light propagates and corresponds to a peak in the about +10° to about +25° directions.

Among unnecessary light caused by off-screen light incident upon the DOE 100 applied to the actual optical system, at least diffracted light of the unnecessary light caused by the off-screen light reaches the image plane when it has a diffraction angle approximately equal to +0.20° at which the designed diffractive order at the designed incident angle propagates.

From the RCWA calculation results, the diffractive efficiency near the diffraction angle of +0.20° in FIGS. 20A and 20B is 0.0028% for the diffractive order of a −48th order (diffraction angle of)+0.32°, and 0.0028% for the diffractive order of a −49th order (diffraction angle of)+0.12°.

It is understood that the diffractive efficiency of the designed order of the +1st order in the contacting two-layer DOE remarkably decreases and is 0.014% for the diffractive order of −46th order (diffraction angle of)+0.34° and 0.014% for the diffractive order of −47th order (diffraction angle of)+0.14°.

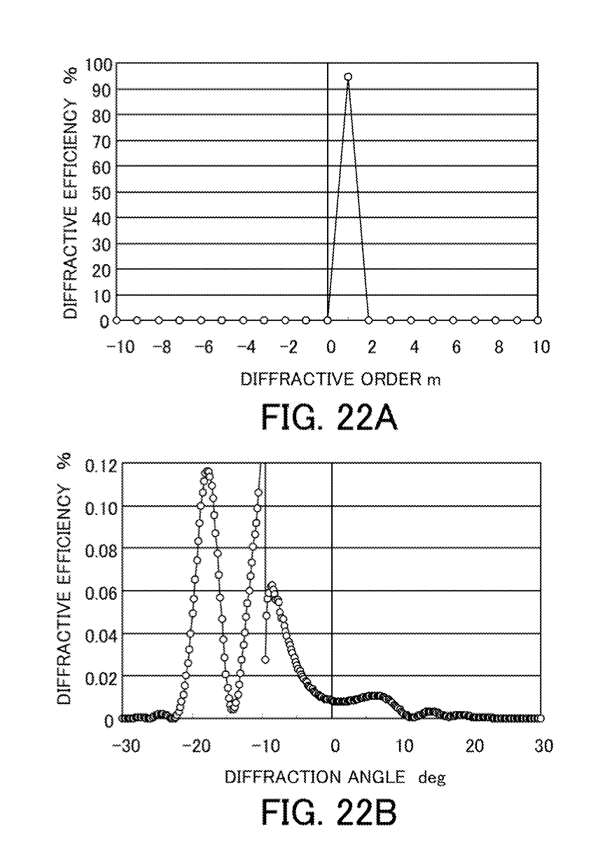

FIGS. 22A and 22B are graphs of RCWA calculation results using an incident angle of −10°, a grating pitch of 100 μm, and a wavelength of 550 nm by supposing a light flux (such as an incident light “c” in FIG. 15 and “Bd” in FIG. 14) which is incident at an obliquely incident angle (off-screen light incident angle) above the designed incident angle of this DOE. The incident angle is set positive in the downward direction in FIG. 15. The upper direction is positive in the and grating of FIG. 14.

FIG. 22A illustrates diffractive efficiency near the +1st order diffracted light as the designed order, where the abscissa axis denotes a diffractive order and the ordinate axis denotes diffractive efficiency (%). FIG. 22B illustrates a high diffraction angle range by enlarging a low diffractive efficiency part of the ordinate axis of FIG. 22A and by converting the diffractive order of the abscissa axis into a diffraction angle. The abscissa axis denotes a diffraction angle (degree), and the ordinate axis denotes diffractive efficiency (%). The diffraction angle is set positive in the downward direction in FIG. 15.

In FIG. 22A, the +1st order diffracted light as the designed order provides the highest diffractive efficiency, but its diffractive efficiency is 94.67% (with a diffractive order of the +1st order and a diffraction angle of −9.80° smaller than that of the designed incident angle of 0° because it is inclined to the designed incident angle of 0°. Since this +1st order diffracted light does not reach the image plane, its influence is small.

The remaining unnecessary light becomes unnecessary light having a peak in the specific angle direction and propagates as illustrated in FIG. 22B, and has peaks in the about −17° direction and in the about +5° to +20° directions.

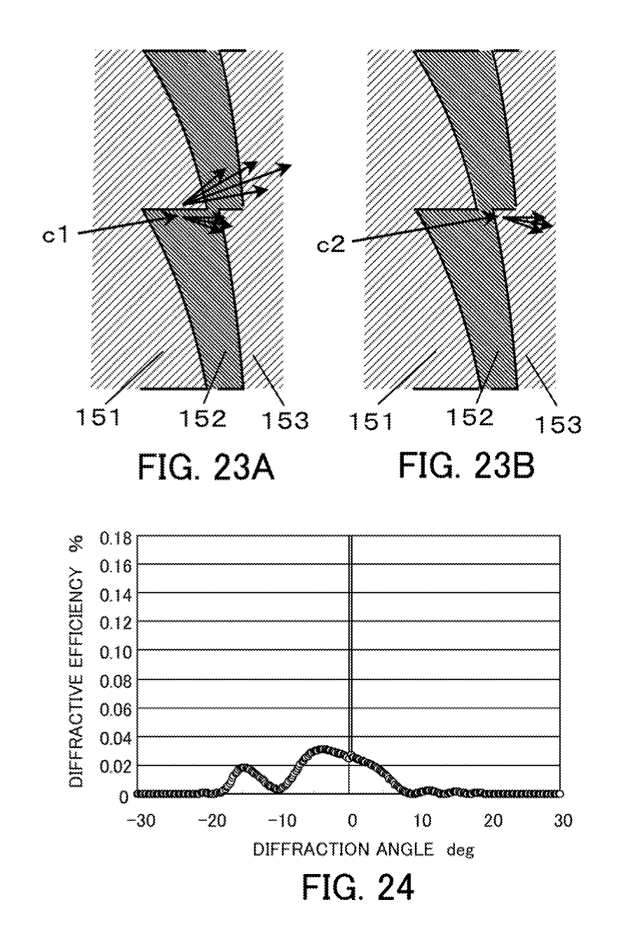

FIGS. 23A and 23B are schematic diagrams of a propagation of unnecessary light for an off-screen light flux having an incident angle of −10° of the DOE 100. FIG. 23A illustrates a component c1 of a light flux that enters and is reflected on the grating wall surface of the first diffraction grating. FIG. 23B illustrates a component “c2” of a light flux that enters and is totally reflected on the grating wall surface of the second diffraction grating from the high refractive index material side to the low refractive index material side.

As illustrated in FIG. 23A, the peak in the about −17° direction on the first diffractive grating corresponds to the peak of the transmitting light derived from the component “c1” of the light flux incident upon the grating wall surface of the first diffraction grating from the low refractive index material side to the high refractive index material side.

It is conceivable that the peak in the about +5° to +20° directions is generated as a result of interference between the component “c1” in FIG. 23A reflected on the grating wall surface of the first diffraction grating and the component “c2” in FIG. 23B totally reflected on the grating wall surface of the second diffraction grating.

Among unnecessary light caused by an off-screen light incident upon the DOE 100 applied to the actual optical system, at least diffracted light of the unnecessary light caused by the off-screen light reaches the image plane when it has a diffraction angle approximately equal to +0.20° at which the designed diffractive order at the designed incident angle propagates.

From the RCWA calculation results, the diffractive efficiency near the diffraction angle of +0.20° in FIGS. 22A and 22B is 0.0088% for the diffractive order of a +48th order (diffraction angle of)+0.32°, and 0.0086% for the diffractive order of a +49th order (diffraction angle of)+0.12°. In the contacting two-layer DOE, the diffractive efficiency of the designed order of the +1st order is 0.0021% for the diffractive order of +49th order (diffraction angle of)+0.26° and 0.0022% for the diffractive order of +48th order (diffraction angle of +0.06° as illustrated in FIGS. 7A and 7B. It is understood that the diffractive efficiency thus increases. Nevertheless, since the diffractive efficiency has an extremely small numerical value, its influence on a drop of the imaging performance is small.

As discussed, when the off-screen light flux enters the optical system that includes the multi-layer DOE, an increase of the unnecessary light can be maintained sufficiently low for the and grating that is less affected by the unnecessary light, and an amount of the unnecessary light can be remarkably reduced for the mu grating that is comparatively affected by the unnecessary light. Thus, the imaging performance can be maintained by reducing an amount of the unnecessary light that would otherwise reach the imaging plane.

### Second Embodiment

A second embodiment is similar to the first embodiment in materials of the DOE but different from the first embodiment in the grating heights d1 and d2. More specifically, the grating height d1 is −16.72 μm, and the grating height d2 is −7.43 μm, m1 is +1.80 and m2 is −0.80 in Expressions 6 and 7, and the designed order is +1st order.

FIG. 24 is a graph of RCWA calculation result using an incident angle of 0° as a designed incident angle of this DOE, a grating pitch of 100 μm, and a wavelength of 550 nm. The abscissa axis denotes a diffraction angle (degree) and the ordinate axis denotes diffractive efficiency (%). The diffractive efficiency of the +1st order diffracted light as the designed order is 97.79%, and the remaining light becomes unnecessary light and propagates as in the first embodiment.

The grating height of this embodiment is larger than that of the first embodiment, and the diffractive efficiency of the +1st order diffracted light of this embodiment is lower than that of the first embodiment. When the overall DOE region is considered in this embodiment, a reduced amount of the diffractive efficiency with a grating pitch of 100 μm is less influential or problematic because it is rare to directly capture a high brightness light source, such as the sun in daylight, at the designed incident angle (an incident angle of image pickup light).

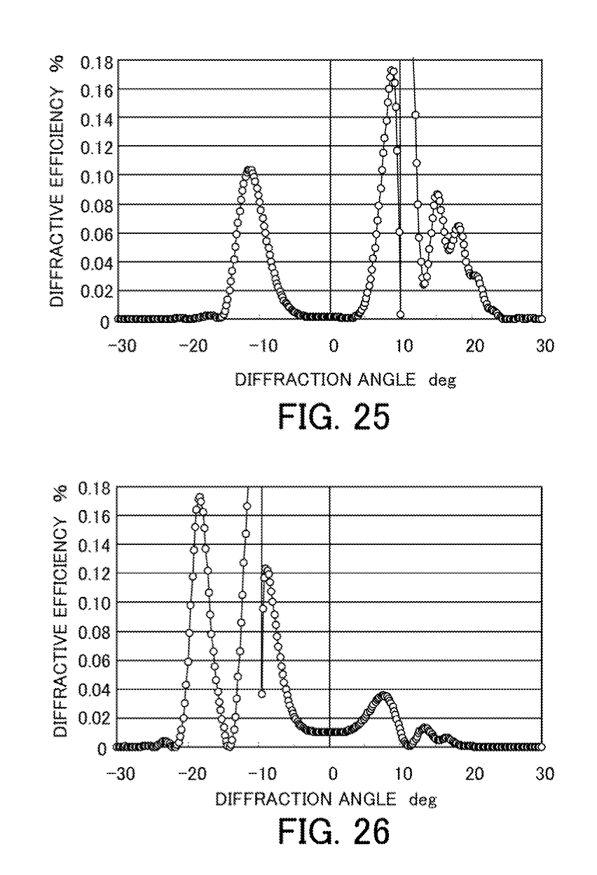

FIG. 25 is a graph of an RCWA calculation result using an incident angle of +10°, a grating pitch of 100 μm, and a wavelength of 550 nm by supposing the incident light which is incident at an obliquely incident angle (off-screen light incident angle) below the designed incident angle of this DOE. The abscissa axis denotes a diffraction angle (degree) and the ordinate axis denotes diffractive efficiency (%).

In FIG. 25, the +1st order diffracted light as the designed order provides the highest diffractive efficiency, but its diffractive efficiency is 88.47% smaller than that of the designed incident angle of 0° because it is inclined to the designed incident angle of 0°. Since the +1st order diffracted light of this off-screen light does not reach the image plane, its influence is small.

The remaining unnecessary light becomes unnecessary light having a peak in a specific angle direction and propagates as in the first embodiment, and a peak of the unnecessary light in the about −10° direction is approximately similar to that of FIG. 5B. However, the angular spread of the unnecessary light is different between FIG. 25 and FIG. 5B and it is understood that the diffractive efficiency of FIG. 25 is lower at the low diffraction angle (low order).

At least diffracted light of unnecessary light caused by an off-screen light reaches the image plane when it has a diffraction angle approximately equal to +0.20° at which the designed diffractive order at the designed incident angle propagates. From the RCWA calculation results, the diffractive efficiency near the diffraction angle of +0.20° in FIG. 24 is 0.0015% for the diffractive order of a −48th order, and 0.0015% for the diffractive order of a −49th order. It is understood that the diffractive efficiency remarkably decreases in comparison with the contacting two-layer DOE.

FIG. 26 is a graph of an RCWA calculation result using an incident angle of −10°, a grating pitch of 100 μm, and a wavelength of 550 nm by supposing the incident light incident at an obliquely incident angle (off-screen light incident angle) above the designed incident angle of this DOE. The abscissa axis denotes a diffraction angle (degree), and the ordinate axis denotes diffractive efficiency (%).

The +1st order diffracted light as the designed order provides the highest diffractive efficiency, but its diffractive efficiency is 91.00% smaller than that of the designed incident angle of 0° because it is inclined to the designed incident angle of 0°. This +1st order diffracted light of the off-screen light incident angle does not reach the image plane, and thus its influence is small. It is understood that the remaining unnecessary light propagates as in the first embodiment.

At least diffracted light of unnecessary light caused by an off-screen light reaches the image plane when it has a diffraction angle approximately equal to +0.20° at which the designed diffractive order at the designed incident angle propagates. From the RCWA calculation results, the diffractive efficiency near the diffraction angle of +0.20° in FIG. 26 is 0.010% for the diffractive order of a +49th order, and 0.010% for the diffractive order of a +48th order. Although the diffractive efficiency is larger than that of the contacting two-layer DOE, a numerical value of the diffractive efficiency is small and thus its influence on a drop of the imaging performance is small.

As discussed, when the off-screen light flux enters the optical system that includes the multi-layer DOE, an increase of the unnecessary light can be maintained sufficiently low for the and grating that is less affected by the unnecessary light, and an amount of the unnecessary light can be remarkably reduced for the mu grating that is comparatively affected by the unnecessary light. Thus, the imaging performance can be maintained by reducing an amount of the unnecessary light that would otherwise reach the imaging plane.

In the first and second embodiments, the conditional expressions that provide the above effects are as follows:

+1.3×|m|<|m1|<+2.0×|m| Expression 8

−1.0×|m|<−|m2|<−0.3×|m| Expression 9

0.94×|m|<|m1+m2|<1.05×|m| Expression 10

Herein, m is a designed order, m1=(nd2−nd1)d1/λd, m2=(nd3−nd2)d2/λd, nd1 is a refractive index of the material 151 to the d-line, nd2 is a refractive index of the material 152 to the d-line, and nd3 is a refractive index of the material 153 to the d-line. Ad is a wavelength of the d-line (587.6 nm), d1 is a grating height of the first diffraction grating, and d2 is a grating height of the second diffraction grating.

In the first and second embodiments, when d1 is set to −9.28 μm and d2 is set to 0 μm, the contacting two-layer DOE is produced and the unnecessary light occurs. The unnecessary light can be reduced by satisfying the lower limits in Expressions 8 and 9. In addition, as the numerical values of m1 and m2 increase, the diffractive efficiency lowers for the designed incident light flux, and the unnecessary light increases for the and grating that is less affected by the unnecessary light. By satisfying the upper limits of Expressions 8 and 9, the diffractive efficiency can be maintained for the designed incident light flux and the unnecessary light can be restrained. By satisfying Expression 10, the diffractive efficiency of the designed order for two diffractive gratings in the multi-layer DOE can be improved.

Moreover, by satisfying the following conditional expressions for the first diffraction grating, the diffractive efficiency can be improved over the visible wavelength range:

25<|vd2−vd1|<40 Expression 11

0.03<|nd2−nd1|<0.22 Expression 12

Herein, vd1 is an Abbe number of the material 151, and vd2 is an Abbe number of the material 152.

By satisfying Expression 11, the diffractive efficiency can be maintained high over the visible wavelength range. By satisfying the lower limit of Expression 12, the grating height can be restrained, the diffractive efficiency can be maintained for the designed incident light flux and for the obliquely incident angle, and the degree of freedom of the optical system can be maintained. By satisfying the upper limit in Expression 12, the interface reflections can be reduced between the materials of the diffraction gratings, and the number of steps, such as the antireflection film forming step, can be reduced.

The diffractive efficiency of the second diffraction grating can be made high over the visible wavelength range by satisfying the following conditional expressions:

25<|vd3−vd2|<40 Expression 13

0.03<|nd3−nd2|<0.22 Expression 14

By satisfying the following conditional expression, the diffractive efficiency can be maintained for the designed incident light flux and for an obliquely incident angle, and the degree of freedom of the optical system can be secured:

|d1|+|d2|<30 μm Expression 15

The diffraction grating material and grating height of the DOE are not limited to those of this embodiment. This embodiment uses the same material for the materials 151 and 153 of the diffraction grating in order to compare the embodiments with the contacting two-layer DOE, but may use different materials for these materials 151 and 153.

While this embodiment sets the +1st order to the designed order, the designed order is not limited because similar effects can be obtained with the designed order of non −+1st order.

The manufacturing method of the DOE of this embodiment is not particularly limited. In an example, the first and second diffraction gratings are manufactured by using molds etc. and the materials 151 and 153 of the diffraction grating. The DOE is manufactured by bonding the two diffractive gratings using the material 152.

In another example, the first diffraction grating is manufactured using the mold etc. and the material 151 of the diffraction grating. Thereafter, the second diffraction grating is manufactured using the first diffraction grating as a mold and the material 152 of the diffraction grating. Thereafter, the DOE is manufactured by bonding it with the substrate lens using the material 153. Cutting, lithography, and etching etc. may be employed without using the mold.

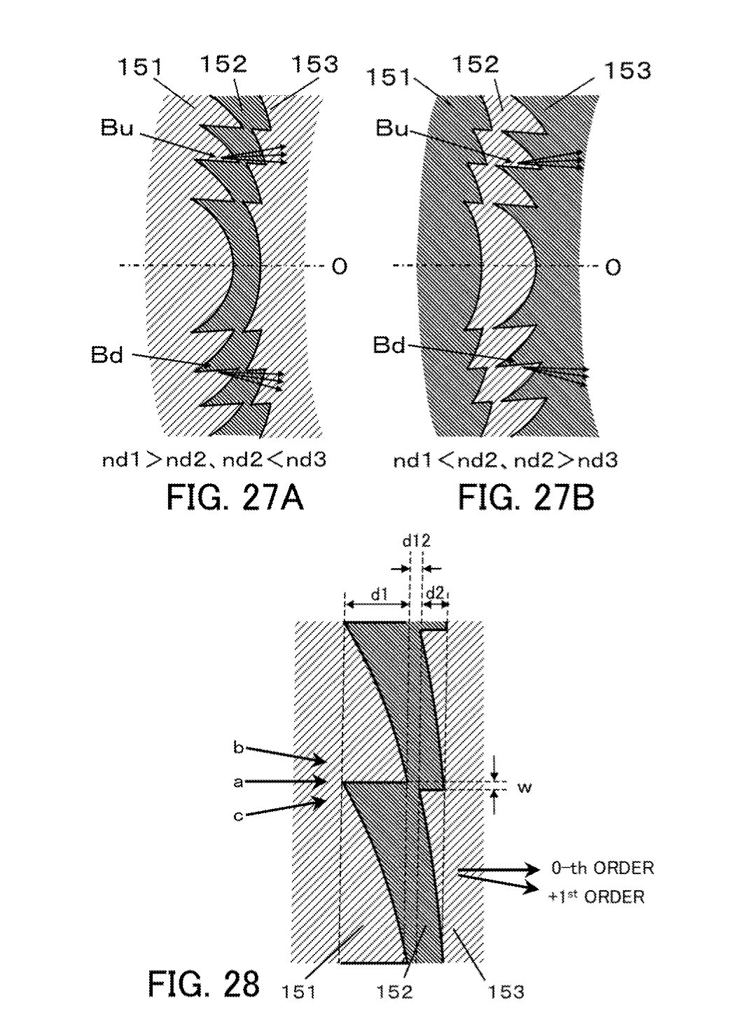

While this embodiment sets nd1>nd2 and nd2<nd3, a description will now be given of a case where nd1<nd2 and nd2>nd3 with reference to FIG. 27. Herein, FIG. 27A is a schematic sectional view of the DOE in which nd1>nd2 and nd2<nd3 are satisfied, and FIG. 27B is a schematic sectional view of the DOE in which nd1<nd2 and nd2>nd3 are satisfied.

As illustrated in FIGS. 27A and 27B, the grating height of the first diffraction grating is larger than that of the second diffraction grating since the refractive index relationship is inverted. As the influence of the second diffraction grating increases and nd2>nd3 is satisfied, unnecessary light similarly occurs. Thus, regarding the refractive index relationship of the grating wall surfaces, nd1>nd2 and nd2<nd3 are similar to nd1<nd2 and nd2>nd3. The present invention is not limited to a difference of such a structure.

Although the peak of the unnecessary light is shielded by the stop 40 as illustrated in FIG. 19, this is merely illustrative and the present invention is not limited to this structure. Unnecessary light can be restrained by introducing a peak of unnecessary light into a lens barrel for light shielding, or by reflecting the peak of the unnecessary light at an angle that does not reach the image plane using the subsequent lens.

### Third Embodiment

A third embodiment is different from the first and second embodiments in the positions of the grating wall surfaces of the first diffraction grating and the second diffraction grating. As illustrated in FIG. 28, the material 151 is acrylic ultraviolet curable resin mixed with ZrO2 nanoparticles (nd=1.5677, νd=47.0, θgF=0.569, and n550=1.5704). The material 152 is fluorine acrylic ultraviolet curable resin mixed with ITO nanoparticles (nd=1.5045, νd=16.3, θgF=0.390, and n550=1.5111). The material 153 is acrylic ultraviolet curable resin mixed with ZrO2 nanoparticles (nd=1.5677, νd=47.0, θgF=0.569, and n550=1.5704).

The grating height d1 is −13.00 μm, and the grating height d2 is −3.71 μm, m1 is +1.40 and m2 is −0.40 in Expressions 6 and 7, and the designed order is +1st order. A grating wall surface of the second diffraction grating is located on the low refractive index region side of the first diffraction grating with respect to an extension of the grating wall surface of the first diffraction grating, and a phase shift width w is 1.00 μm. The low refractive index region side of the first diffraction grating is a side on which a region of the low refractive index material is wider with respect to the interface of the grating wall surface (or under the extension of the grating wall surface of the first diffraction grating in FIG. 27). An interval d12 between the first diffraction grating and the second diffraction grating is 1.00 μm.

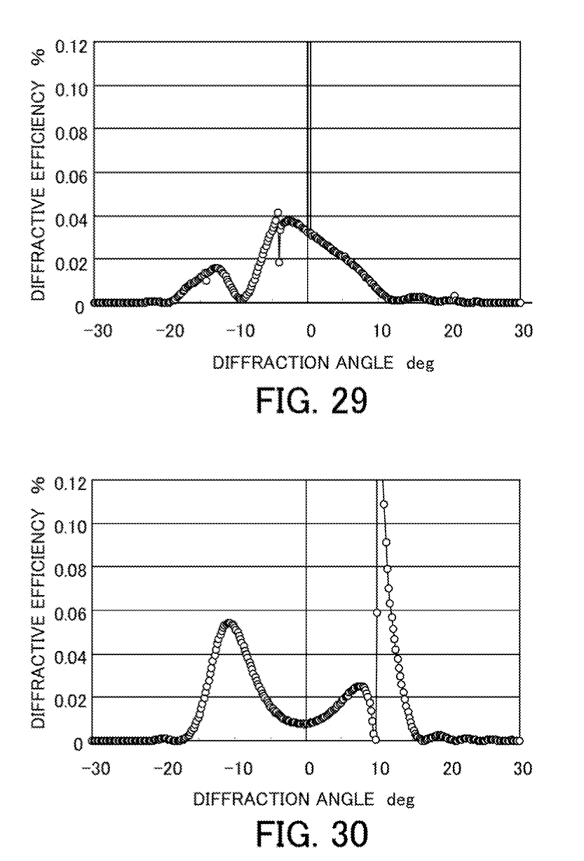

FIG. 29 is a graph of an RCWA calculation result using an incident angle of 0° as a designed incident angle of this DOE, a grating pitch of 100 μm, and a wavelength of 550 nm. The abscissa axis denotes a diffraction angle (degree), and the ordinate axis denotes diffractive efficiency (%). The diffractive efficiency of the +1st order diffracted light as the designed order is 97.28%, and the remaining light becomes unnecessary light and propagates as in the first embodiment.

In addition, the diffractive efficiency of the +1st order diffracted light of this embodiment is lower than that of the first embodiment. This is because the phase shift occurs due to the positional shift between the grating wall surface of the first diffraction grating and the grating wall surface of the second diffraction grating. When the overall DOE region is considered in this embodiment, a reduced amount of the diffractive efficiency with a grating pitch of 100 μm is seldom influential or problematic because it is rare to directly capture a high brightness light source, such as the sun in daylight, at the designed incident angle (an incident angle of image pickup light).

FIG. 30 is a graph of an RCWA calculation result using an incident angle of +10°, a grating pitch of 100 μm, and a wavelength of 550 nm by supposing an incident light incident at an obliquely incident angle (off-screen light incident angle) below the designed incident angle of this DOE. The abscissa axis denotes a diffraction angle (degree) and the ordinate axis denotes diffractive efficiency (%). The +1st order diffracted light as the designed order provides the highest diffractive efficiency, but its diffractive efficiency is 95.33% smaller than that of the designed incident angle of 0° because it is inclined to the designed incident angle of 0°. This +1st order diffracted light of the off-screen light incident angle does not reach the image plane, and thus its influence is small.

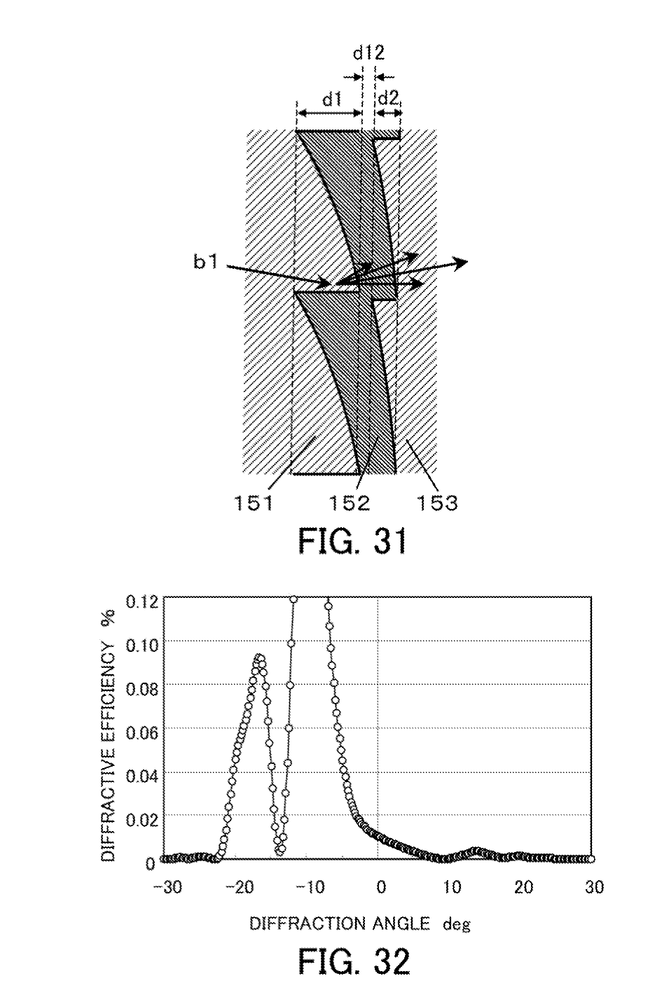

It is conceivable that the remaining unnecessary light becomes unnecessary light having a peak in a specific angle direction and propagates as illustrated in FIG. 31. This unnecessary light has a peak in the about −10° direction as in the first embodiment. It is understood as illustrated in FIG. 30 that the propagating direction of the peak in the about +10° direction is approximately equal to the exiting direction of +10° of the reflected light that is made as a result of that the off-screen light flux having an incident angle of −10° incident upon the grating wall surface of the first diffractive grating is reflected there.

The peak angle of the unnecessary light in the −10° direction is similar to that of FIG. 5B, but the angular spread is different between FIG. 30 and FIG. 5B and it is understood that the diffractive efficiency of FIG. 30 is lower at the low diffraction angle (low order). At least diffracted light of unnecessary light caused by an off-screen light reaches the image plane when it has a diffraction angle approximately equal to +0.20° at which the designed diffractive order at the designed incident angle propagates.

From the RCWA calculation results, the diffractive efficiency near the diffraction angle of +0.20° in FIG. 29 is 0.0081% for the diffractive order of a −48th order, and 0.0080% for the diffractive order of a −49th order. It is understood that the diffractive efficiency is lower than that of the contacting two-layer DOE.

FIG. 32 is a graph of an RCWA calculation result using an incident angle of −10°, a grating pitch of 100 μm, and a wavelength of 550 nm by supposing the incident light incident at an obliquely incident angle (off-screen light incident angle) above the designed incident angle of this DOE. The abscissa axis denotes a diffraction angle (degree), and the ordinate axis denotes diffractive efficiency (%). The +1st order diffracted light as the designed order provides the highest diffractive efficiency, but its diffractive efficiency is 91.61% smaller than that of the designed incident angle of 0° because it is inclined to the designed incident angle of 0°. This +1st order diffracted light of the off-screen light incident angle does not reach the image plane, and thus its influence is small.

It is understood that the remaining unnecessary light propagates as in the first embodiment. At least diffracted light of unnecessary light caused by off-screen light reaches the image plane when it has a diffraction angle approximately equal to +0.20° at which the designed diffractive order at the designed incident angle propagates.

From an RCWA calculation result, the diffractive efficiency near the diffraction angle of +0.20° in FIG. 26 is 0.011% for the diffractive order of a +49th order, and 0.010% for the diffractive order of a +48th order. Although the diffractive efficiency is larger than that of the contacting two-layer DOE, a numerical value of the diffractive efficiency is small and its influence on a drop of the imaging performance is small.

As discussed, when the off-screen light flux enters the optical system that includes the multi-layer DOE, an increase of the unnecessary light can be maintained sufficiently low for the and grating that is less affected by the unnecessary light, and an amount of the unnecessary light can be remarkably reduced for the mu grating that is comparatively affected by the unnecessary light. Thus, the imaging performance can be maintained by reducing an amount of the unnecessary light that would otherwise reach the imaging plane.

### Comparative Example 2

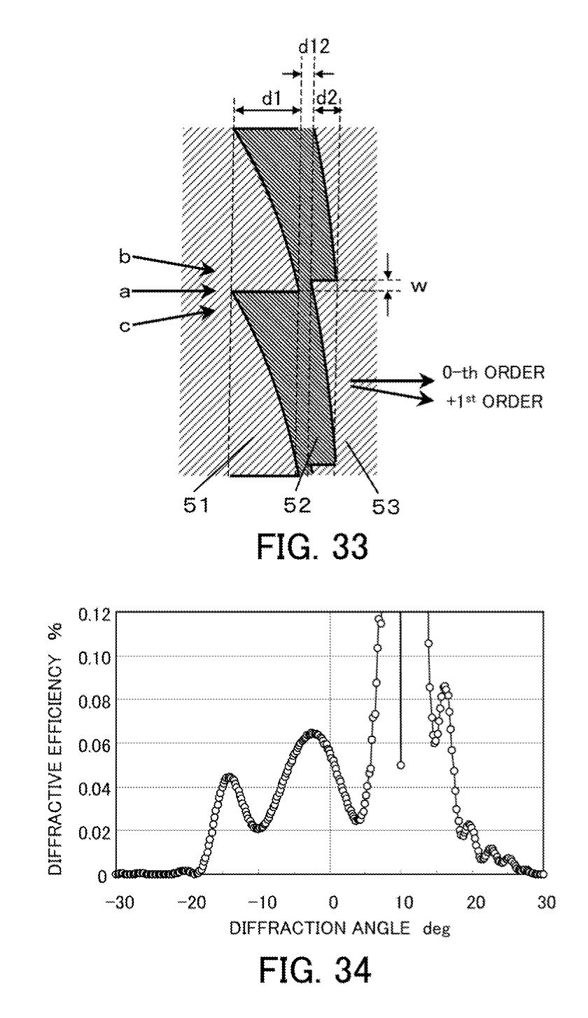

A comparative example 2 is different from the third embodiment in positions of the grating wall surfaces of the first and second diffraction gratings, and other than that the comparative example 2 is similar to the third embodiment. Regarding the positional relationship of the grating wall surface, as illustrated in FIG. 33, the grating wall surface of the second diffraction grating is located on the high refractive index region side of the first diffraction grating with respect to the extension of the grating wall surface of the first diffraction grating. The high refractive index region side of the first diffraction grating is a side on which a region of the high refractive index material is wider with respect to the interface of the grating wall surface (above the extension of the grating wall surface of the first diffraction grating in FIG. 33).

In FIG. 33, a material corresponding to the material 151 is designated by a material 51, a material corresponding to the material 152 is designated by a material 52, and a material corresponding to the material 153 is designated by a material 53.

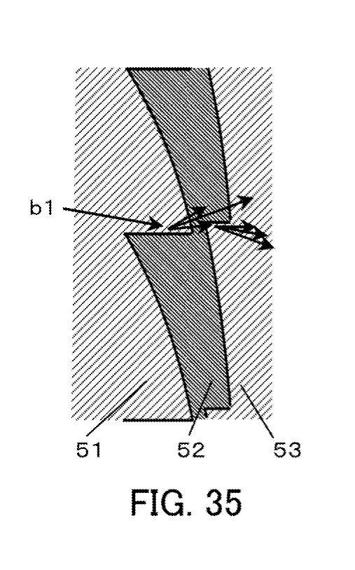

FIG. 34 is a graph of an RCWA calculation result using an incident angle of +10°, a grating pitch of 100 μm, and a wavelength of 550 nm by supposing incident light which is incident at an obliquely incident angle (off-screen light incident angle) below the designed incident angle of this DOE. The abscissa axis denotes a diffraction angle (degree), and the ordinate axis denotes diffractive efficiency (%). It is conceivable that unnecessary light propagates with a plurality of peaks as illustrated in FIG. 35.

This unnecessary light propagates its peak near the diffraction angle of +0.20° at which the designated diffractive order propagates at the designed incident angle. Conceivably, this is because the reflected light made as a result of that the off-screen light flux having an incident angle of +10° incident upon the grating wall surface of the first diffraction grating is reflected on the grating wall surface of the first diffraction grating enters and is again reflected on the grating wall surface of the second diffraction grating as illustrated in FIG. 35.

Among unnecessary light caused by an off-screen light incident upon the above DOE applied to the actual optical system, at least diffracted light of unnecessary light caused by off-screen light reaches the image plane when it has a diffraction angle approximately equal to +0.20° at which the designed diffractive order at the designed incident angle propagates.

From an RCWA calculation result, the diffractive efficiency near the diffraction angle of +0.20° in FIG. 34 is 0.027% for the diffractive order of a −46th order, and 0.027% for the diffractive order of a −47th order. These diffraction efficiencies are remarkably larger than those of the contacting two-layer DOE since the contacting two-layer DOE exhibits the diffractive efficiency of 0.014% for the diffractive order of a −46th order and the diffractive efficiency of 0.014% for the diffractive order of a −47th order.

According to the multi-layer DOE of the present invention, the grating wall surface of the second diffraction grating is located on the low refractive index region side of the first diffraction grating with respect to the extension of the grating wall surface of the first diffraction grating. With no positional shift, the diffractive efficiency becomes higher at the designed incident angle, but when the manufacturing tolerance is particularly considered it is understood that the grating wall surface of the second diffraction grating may be located on the low refractive index region side of the first diffraction grating. Thereby, the DOE that stably restrains the unnecessary light can be manufactured.

As the positional shift width of the grating wall surface increases, the diffractive efficiency at the designed incident angle becomes lower and the imaging performance cannot be ignored. Thus, the positional shift width may satisfy the following conditional expression:

0≦w/P≦0.05 Expression 16

Herein, P is a grating pitch, w is a positional shift width between the grating wall surface of the first diffraction grating and that of the second diffraction grating in a direction orthogonal to the optical axis of the DOE. The diffraction grating having a grating pitch of 100 μm as one reference is illustrated, but a positional shift width w and a grating pitch P have a linear relationship for the diffractive efficiency of the designed order. The diffractive efficiency of the designed order of the diffraction grating having the grating pitch P and the positional shift width w is approximately equal to that of the designed order of the diffraction grating having the grating pitch P×2 and the positional shift width w×2.

For example, the diffractive efficiency of the designed order of the diffraction grating in the third embodiment having the grating pitch 100 μm and a positional shift width of 1.0 μm is approximately equal to that of the designed order of the diffraction grating having a grating pitch 200 μm and a positional shift width of 2.0 μm. Therefore, Expression 16 between the grating pitch P and the positional shift width is established. Expression 16 may be replaced with Expression 17. Satisfying Expression 17 provides a DOE that does not deteriorate the imaging performance:

0≦w/P≦0.02 Expression 17

Table 1 summarizes the results of Expressions 8 to 17 for the first to third embodiments:

TABLE 1

| | First | Second | Third |
|---|---|---|---|
| | Embodiment | Embodiment | Embodiment |
| m | 1 | 1 | 1 |
| m1 | 1.40 | 1.80 | 1.40 |
| m2 | −0.40 | −0.80 | −0.40 |
| m1 + m2 | 1 | 1 | 1 |
| \|vd2 − vd1\| | \|16.3 − 47.0\| = 30.7 | 30.7 | 30.7 |
| \|nd2 − nd1\| | \|1.5045 − 1.5677\| = 0.0632 | 0.0632 | 0.0632 |
| w/P | 0 | 0 | 0.01 |
| \|vd3 − vd2\| | 30.7 | 30.7 | 30.7 |
| \|nd3 − nd2\| | 0.0632 | 0.0632 | 0.0632 |
| \|d1\| + \|d2\| | 20.71 | 24.15 | 16.71 |

The above embodiments utilize, but are not limited to, a resin material in which nanoparticles are dispersed for the material of the diffraction grating unit. For example, an organic material such as a resin material, a glass material, an optical crystal material, a ceramics material may also be used. An inorganic nanoparticle material of any of oxide, metal, ceramics, compounds, and mixtures thereof can be used as the nanoparticle material used to disperse the nanoparticles, but the embodiments are not limited to these nanoparticle materials.

An average particle diameter of the nanoparticle material may be less than or equal to one fourth as large as the wavelength (the working wavelength or the designed wavelength) of the incident light upon the DOE. If the nanoparticle diameter is greater than this value, the Rayleigh scattering may be influential when the nanoparticle material is mixed with the resin material. As the resin material with which the nanoparticle material is mixed, a UV curing resin that is acrylic, fluoric, vinyl and epoxy organic resin may be applicable although the resin material is not limited.

For example, the material 151 may use acrylic ultraviolet curable resin (nd=1.5218, vd=51.27), the material 152 may use fluorine acrylic ultraviolet curable resin mixed with ITO nanoparticles (nd=1.4783, vd=21.00), and the material 153 may use acrylic ultraviolet curable resin (nd=1.5218, vd=51.27). According to the structure similar to the first embodiment, when the grating heights d1=−20.26 μm and d2=−6.75 μm, m1=1.5, m2=−0.5, m1+m2=1, |vd2−vd1|=30.26, and |nd2−nd1|=0.043 are confirmed. Therefore, high diffractive efficiencies could be obtained by satisfying Expressions 8 to 17 and by restraining the unnecessary light.

Alternatively, the material 151 may use thioacrylic ultraviolet curable resin mixed with ITO nanoparticles (nd=1.8100, vd=40.99), the material 152 may use low-melting glass (nd=1.6811, vd=11.93), and the material 153 may use thioacrylic ultraviolet curable resin mixed with ITO nanoparticles (nd=1.8100, vd=40.99). According to the structure similar to the first embodiment, when the grating heights d1=−6.83 μm and d2=−2.27 μm, m1=1.5, m2=−0.5, m1+m2=1, |vd2−vd1|=29.06, and |nd2−nd1|=0.13 are confirmed. Therefore, high diffractive efficiencies could be obtained by satisfying Expressions 8 to 17 and by restraining the unnecessary light.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-226882, filed on Oct. 6, 2010, which is hereby incorporated by reference herein in their entirety.

What is claimed is:

1. A diffractive optical element used for a lens surface in an optical system, the diffractive optical element comprising:
a first diffraction grating made by adhering a grating interface of a diffractive grating made of a first material to a grating interface of a diffractive grating made of a second material; and
a second diffraction grating made by adhering a grating interface of the diffractive grating made of the second material to a grating interface of a diffractive grating made of a third material,
wherein a grating wall surface of the second diffractive grating is located on a surface extending a grating wall surface of the first diffractive grating or on a low refractive index region side of the first diffractive grating with respect to the surface extending the grating wall surface of the first diffractive grating, and
wherein the following conditional expressions are satisfied,
+1.3×|m|<|m1|<+2.0×|m|,
−1.0×|m|<−|m2|<−0.3×|m|, and
0.94×|m|<|m1+m2|<1.05×|m|,
where m is a designed order, m1=(nd2−nd1)d1/λd, m2=(nd3−nd2)d2/λd, nd1 is a refractive index of the first material to d-line, nd2 is a refractive index of the second material to the d-line, nd3 is a refractive index of the third material to the d-line, λd is a wavelength of the d-line, d1 is a grating height of the first diffraction grating, and d2 is a grating height of the second diffraction grating.

2. The diffractive optical element according to claim 1, wherein the following conditional expressions are satisfied:
25<|vd2−vd1|<40
0.03<|nd2−nd1|<0.22
where vd1 is an Abbe number of the first material to the d-line, and vd2 is an Abbe number of the second material to the d-line.

3. The diffractive optical element according to claim 1, wherein the following conditional expressions are satisfied:
25<|vd3−vd2|<40
0.03<|nd3−nd2|<0.22
where vd2 is an Abbe number of the second material to the d-line, and vd3 is an Abbe number of the third material to the d-line.

4. The diffractive optical element according to claim 1, wherein the following conditional expression is satisfied:

|d1|+|d2|<30 μm.

5. The diffractive optical element according to claim 1, wherein the designed order is a +1^{st} order or a −1^{st} order.

6. The diffractive optical element according to claim 1, wherein the first material is the same material as the third material.

7. The diffractive optical element according to claim 1, wherein the following conditional expression is satisfied:
0≦w/P≦0.05
where P is a grating pitch, w is a positional shift width between the grating wall surface of the first diffractive grating and the grating wall surface of the second diffractive grating in a direction orthogonal to an optical axis of the diffractive optical element.

8. An optical system comprising:
a diffractive optical element according to claim 1; and
a stop arranged at a rear side of the diffractive optical element along an optical path.

9. An optical apparatus including the optical system according to claim 8.
